(19) United States
(12) Patent Application Publication
(10) Pub. No.: US 2025/0047188 A1
(43) Pub. Date: Feb. 6, 2025

(54) RESONANT COMMUTATION AND QUASI-TRAPEZOIDAL CURRENT CONTROL IN ELECTRONIC TRANSFORMERS

(71) Applicant: VIRGINIA TECH INTELLECTUAL PROPERTIES, INC., Blacksburg, VA (US)

(72) Inventors: Yuliang Cao, Blacksburg, VA (US); Dong Dong, Blacksburg, VA (US)

(21) Appl. No.: 18/364,113

(22) Filed: Aug. 2, 2023

(51) Int. Cl. H02M 1/08; H02M 3/00; H02M 3/335

(52) U.S. Cl. CPC H02M 1/08; H02M 3/01; H02M 3/33573; H02M 3/33584

(57) ABSTRACT

Power converters including electronic-embedded transformers for current sharing and load-independent voltage gain are described. An example power converter system includes an input, an output, a power converter between the input and output, and a controller. The converter includes a first bridge, a second bridge, and an electronic-embedded transformer between the first and second bridge. The electronic-embedded transformer includes a bidirectional coupling switch bridge. The controller generates drive control signals for quasi-trapezoidal current modulation control of the bidirectional coupling switch bridge. The controller is configured to generate the drive control signals based on a commutation coefficient k and a switching frequency for the power converter. The commutation coefficient k can be set based on an inductance in the electronic-embedded transformer, a capacitance in the bidirectional coupling switch bridge, and a margin for resonant current commutation.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

An isolated bidirectional DC transformer (DCX) is one example of a power converter. DCX converters play a significant role in applications such as electric vehicle (EV) chargers, high voltage data center power systems, energy storage systems, solid-state transformers, and other applications. DCX converters can interface two different DC buses or loads with high conversion efficiency. Series resonant converters (SRC), such as LLC or CLLC converters, are popular forms of DCX converters, due to the full load range zero voltage switching (ZVS) operation, low circulating current, and no requirement for voltage regulation offered by such converters.

### SUMMARY

Power converters including electronic-embedded transformers for current sharing and load-independent voltage gain are described. An example power converter system includes an input, an output, a power converter between the input and output, and a controller. The converter includes a first bridge, a second bridge, and an electronic-embedded transformer between the first and second bridge. The electronic-embedded transformer includes a bidirectional coupling switch bridge. The controller generates drive control signals for quasi-trapezoidal current modulation control of the bidirectional coupling switch bridge. The controller is configured to generate the drive control signals based on a commutation coefficient k and a switching frequency for the power converter. The commutation coefficient k can be set based on an inductance in the electronic-embedded transformer, a capacitance in the bidirectional coupling switch bridge, and a margin for resonant current commutation. In another example, an electronic-embedded transformer for a power converter includes a primary winding, a secondary winding, a resonant inductor for use in the power converter, a bidirectional coupling switch bridge, and a controller configured to generate drive control signals for quasi-trapezoidal current modulation control of the bidirectional coupling switch bridge. The resonant inductor can be embodied as leakage inductance among the primary winding and the secondary winding.

In another example, a power converter system includes a power converter having a first bridge of switching devices and a second bridge of switching devices, an electronic-embedded transformer between the first bridge and the second bridge, and a controller. The electronic-embedded transformer can include a bidirectional coupling switch bridge, and the bidirectional coupling switch bridge can include switching devices Q₁ and Q₂ and capacitors Cₒ₁ and Cₒ₂. The controller can be configured to generate switching control signals for the first bridge of switching devices and the second bridge of switching devices and generate drive control signals for the switching devices Q₁ and Q₂.

Among the embodiments, the bidirectional coupling switch bridge can include bidirectional switching devices Q₁ and Q₂ and capacitors Cₒ₁ and Cₒ₂. The drive control signals can control switching operations of the bidirectional switching devices Q₁ and Q₂. The controller can be configured to generate the drive control signals based on a commutation coefficient k and a switching frequency for the power converter.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates an example isolated bidirectional resonant DC transformer (DCX) according to aspects of the embodiments.

FIG. 2 illustrates another example of the DCX shown in FIG. 1 according to aspects of the embodiments.

FIG. 3 illustrates an example of a DCX with voltage regulation according to aspects of the embodiments.

FIG. 4 illustrates another example of a DCX with voltage regulation according to aspects of the embodiments.

FIG. 5 illustrates another example of a DCX with voltage regulation according to aspects of the embodiments.

FIG. 6 illustrates a more detailed schematic diagram of the DCX shown in FIG. 2 according to aspects of the embodiments.

FIG. 7 illustrates an example of certain voltages and currents in the DCX shown in FIG. 2 during resonant operation according to aspects of the embodiments.

FIG. 8 illustrates an example of a DCX with parallel transformers according to aspects of the embodiments.

FIG. 9 illustrates an example of a DCX with a resonant commutation electronic-embedded transformer (RC EET) according to aspects of the embodiments.

FIG. 10 illustrates example control timings for control of the RC EET-DCX shown in FIG. 9 according to aspects of the embodiments.

FIG. 11 illustrates the independent voltage gain of the RC EET-DCX shown in FIG. 9 according to aspects of the embodiments.

FIG. 12 illustrates steady state waveforms of the RC EET-DCX shown in FIG. 9 under different load conditions according to aspects of the embodiments.

FIG. 13 illustrates normalized transformer current with different commutation coefficients for the RC EET-DCX shown in FIG. 9 according to aspects of the embodiments.

FIG. 14 illustrates normalized root mean square transformer current and normalized peak voltage with different commutation coefficients for the RC EET-DCX shown in FIG. 9 according to aspects of the embodiments.

FIG. 15A illustrates three transformer-level parallel solutions, including a CLLC, a EET-DCX, and an RC EET-DCX according to aspects of the embodiments.

FIG. 15B illustrates simplified equivalent circuits for the parallel solutions shown in FIG. 15A according to aspects of the embodiments.

FIG. 16 illustrates the impact of the tolerance on the leakage inductance for the RC EET-DCX shown in FIG. 9 according to aspects of the embodiments.

FIG. 17 illustrates simulated waveforms for the RC EET-DCX shown in FIG. 9 with three paralleled transformers according to aspects of the embodiments.

FIG. 18 illustrates the impact of phase shift tolerance on the RC EET-DCX shown in FIG. 9, with a single transformer, according to aspects of the embodiments.

FIG. 19 illustrates normalized transformer current for the RC EET-DCX shown in FIG. 9 with different k according to aspects of the embodiments.

FIG. 20 illustrates a phasor diagram for multiple paralleled RC EETs according to aspects of the embodiments.

FIG. 21 illustrates simulated waveforms for the RC EET-DCX shown in FIG. 9 with three paralleled transformers and phase tolerance according to aspects of the embodiments.

FIG. 22 illustrates example efficiency results for an RC EET-DCX and an EET-DCX according to aspects of the embodiments.

FIG. 23 illustrates an example of an RC EET-DCX with a parallel arrangement of RC EETs according to aspects of the embodiments.

FIG. 24 illustrates an example of an RC EET-DCX with a series arrangement of RC EETs according to aspects of the embodiments.

FIG. 25 illustrates an example power converter system including a number of RC EET modules according to aspects of the embodiments.

### DETAILED DESCRIPTION

To meet the demands for electrical vehicle (EV) charging systems, energy storage systems (ESSs), data center power supplies, solid-state transformer (SST) systems, and related systems, bidirectional fixed-ratio DC-DC converters, namely DC transformer (DCX) power converters, have been widely adopted. DCX-based power converters can interface two different DC buses or loads with high conversion efficiency. Due to the simple control, fixed switching frequency, and the galvanic isolation they provide, DCX-based power converters can provide a very high conversion efficiency path when used to bridge two DC buses. DCX converters can also provide galvanic (i.e., electrical) isolation between the input and output of the DCX. DCX converters also provide bidirectional power flow, load-independent constant voltage gain, and high efficiency with simple open loop control. If output voltage regulation is required, a front-end AC/DC stage, a rear-end DC/DC stage, or an input-parallel-output-series (IPOS) DC regulator can be adopted.

To meet high-power and high-density requirements at the same time, the use of increased switching frequencies in DCX-based power converters is already a trend. With the fast development of wide band gap (WBG) semiconductor materials, such as gallium nitride (GaN) and silicon carbide (SiC), some of the high-frequency design challenges can be addressed by adopting high-current/voltage high-efficient SiC/GaN power modules.

A range of DCX-based power converters are known, including unregulated, semi-regulated, and regulated converters. Two common circuit topologies for DCX power converters include the dual active bridge (DAB) and the series resonant converter (SRC). SRC-based DCX converters can be more desirable because they have lower circulating currents and can operate with full zero voltage switching (ZVS). Particularly, SRC-based DCX power converters, such as LLC or CLLC converters, are popular forms of DCX converters, due to the full load range ZVS operation, low circulating current, and open loop control with no requirement for voltage regulation. SRC-based DCX converters can also be designed using a number of different topologies, such as full-bridge LLC converters with full-bridge rectifiers, half-bridge LLC converters with a half-bridge rectifiers, and others. Parallel resonant DCX converters and series-parallel DCX converters are also known.

Overall, compared with DAB converters, LLC resonant converters are more desirable because of the lower circulating current and full load range zero voltage switching (ZVS). Moreover, when the resonant LLC/CLLC converters operate at (or slightly below) the resonant frequency as an LLC/CLLC-DCX, it can provide a load-independent constant voltage gain without any closed-loop voltage control. When a DCX-based power converter operates as a resonant converter, the leakage inductance of the high-frequency transformer should be minimized because a larger leakage inductance will cause a higher current ringing during the deadtime and a higher voltage stress on the resonant capacitor.

However, the design of DCX-based power converters operating at high-frequencies (e.g., over 100 kHz) with both high power-rating and high-efficiency remains challenging because of several fundamental design issues. As mentioned above, to transfer high power with LLC/CLLC DCX-based power converters at high frequencies, the leakage inductance should be minimized. Two common ways to reduce leakage inductance include interleaving the primary and secondary windings and more compact designs with smaller parasitic parameters. Still, in high-power applications, either high voltage or high current will bring challenges for the minimization of leakage inductance. For high-voltage applications, enough clearance between the primary and secondary sides is required, which limits the interleaving technique and perfect coupling. On the other hand, for high-current applications, more space is required for transformer cooling, which is difficult to achieve with a compact design.

Additionally, DCX-based power converters can incorporate transformer paralleling and modularization techniques to overcome certain design trade-offs as compared to the use of a single transformer. A transformer-level paralleling solution can be more desirable because a single full rating power inverting/rectifying bridge achieves high-density integration and lower costs with the use of a smaller number of gate drivers and auxiliary components. However, paralleling transformers is challenging in SRC-based DCX converters because current sharing among paralleled high-frequency transformers is very sensitive to the resonant tank parameters in the transformers. The current sharing is determined by the loop impedance of each transformer, which is mainly determined by the total leakage inductance of each transformer in the high-frequency range. As mentioned above, the leakage inductance of each high-frequency transformer should be minimized, as any small inductance mismatch from manufacturing will lead to a significant current sharing mismatch. Even if there is a small parameter tolerance between two resonant tanks among shared transformers, the more current will go through the resonant tank having a smaller impedance, which can lead to poor efficiency and thermal issues. Some approaches have been explored to address current sharing issues in parallelized SRC-based DCX converters. The approaches have various drawbacks, however, such as complicated transformer designs, limited operating parameters and applications, and topologies that are difficult to scale and modularize.

To address such current-sharing issues and provide a better solution for DCX-based power converters capable of higher power operation and power density, DCX-based power converters including EETs (“EET-DCX power converters”) are described in U.S. patent application Ser. No. 17/819,353, titled “ELECTRONIC TRANSFORMER FOR CURRENT SHARING AND LOAD-INDEPENDENT VOLTAGE GAIN,” filed Aug. 12, 2022 (“the '353 application”), the entire contents of which is hereby incorporated herein by reference. With a simple open-loop control for both the high voltage (HV) and low voltage (LV) bridges in the EET-DCX power converters described in the '353 application, the EET-DCX power converters can provide a load-independent constant voltage gain with a natural current sharing among different EET units. The EET-DCX power converters offer simple open-loop control, transformer-level parallelizing, natural current sharing, robust load-independent voltage gain, optimal operation at any frequency, and scalability.

The EET-DCX power converters described in the '353 application can still be improved, however. For example, the EET-DCX power converters operate with a triangular transformer current without considering the magnetizing inductance. Compared with the sinusoidal current in traditional resonant CLLC-DCX power converters, the triangular current exhibits a larger root mean square (rms) value, which will cause higher conduction losses in both the HV and LV devices and in the transformer windings. EET-DCX power converters also rely upon four active switches to form the LV bridge. The additional active switches result in more losses and cost.

In the context outlined above, a number of DCX-based power converter embodiments including resonant commutation electronic-embedded transformers (RC EETs) are described herein (“RC EET-DCX power converters”). The RC EET-DCX power converters including RC EETs have decreased rms current and rely upon fewer active switches in the LV bridge. Additionally, a new quasi-trapezoidal current modulation technique for RC EET-DCX power converters is also described herein. According to the concepts described herein, the transformer current commutation from “positive” to “negative” utilizes a resonance between paralleled capacitors and transformer leakage inductances Lₖ. In some examples, as compared with the triangular and sinusoidal currents in EET-DCX and CLLC-DCX power converters, the rms current can be reduced up to 15% and 11%, respectively.

By employing resonant modulation, the quasi-trapezoidal currents in RC EET-DCX power converters exhibit smaller rms and peak values under the same power transfer conditions. The proposed RC EET-DCX power converters benefit from lower conduction and switching losses due to lower rms currents, lower peak currents, and the use of fewer active switching devices in the LV bridge. Additionally, the LV bridge in the RC EET can be implemented as a monolithic bidirectional switch, which is undergoing rapid development and can further reduce the total losses and cost. All the advantages associated with the EET-DCX presented in the '353 application, such as natural current sharing and load-independent voltage gain, among other advantages, are retained in the RC EET-DCX power converters described herein.

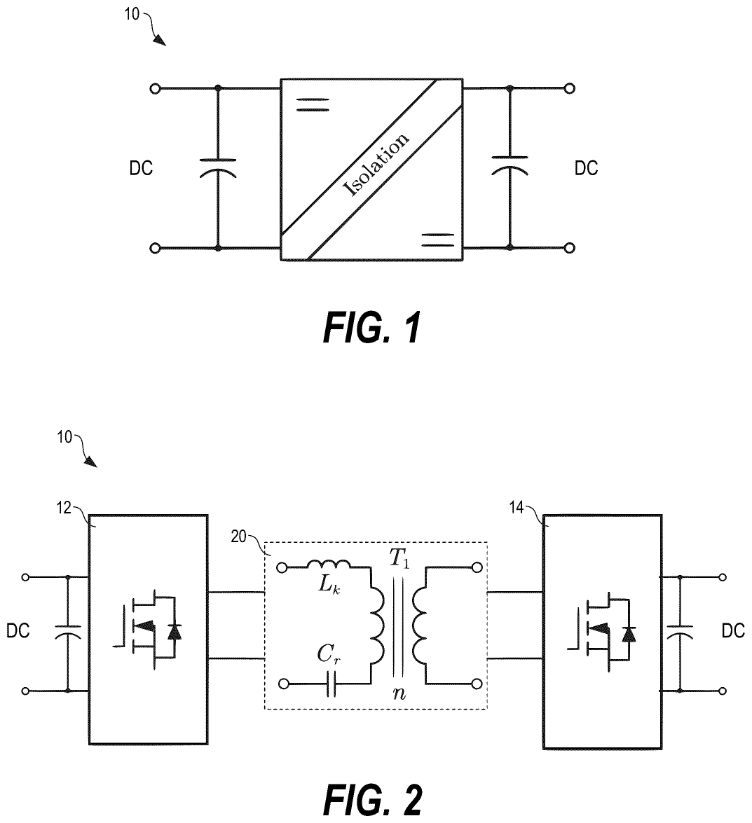

According to aspects of the embodiments, power converters including converters including electronic-embedded transformers for current sharing and load-independent voltage gain are described. An example power converter system includes an input, an output, a power converter between the input and output, and a controller. The converter includes a first bridge, a second bridge, and an electronic-embedded transformer between the first and second bridge. The electronic-embedded transformer includes a bidirectional coupling switch bridge. The controller generates drive control signals for quasi-trapezoidal current modulation control of the bidirectional coupling switch bridge. The controller is configured to generate the drive control signals based on a commutation coefficient k and a switching frequency for the power converter. The commutation coefficient k can be set based on an inductance in the electronic-embedded transformer, a capacitance in the bidirectional coupling switch bridge, and a margin for resonant current commutation. Turning to the drawings, FIG. 1 illustrates an example isolated bidirectional resonant DCX converter 10 (“DCX 10”) according to aspects of the embodiments. The DCX 10 is electrically coupled between a first or input DC bus and a second or output DC bus as shown. The DCX 10 can provide galvanic isolation and bidirectional power flow between the input and the output with high efficiency and simple open loop control. The DCX 10 is an SRC-based DCX converter, as described in further detail below, although the concepts described herein are not limited to use with only SRC-based DCX converters. The concepts can be applied to other types of DCX converters in some cases and to other types of converters.

FIG. 2 illustrates another example of the DCX 10 shown in FIG. 1. The DCX 10 includes a first or input switching bridge 12, a second or output switching bridge 14, and a transformer 20 coupled between the switching bridges 12 and 14. The input switching bridge 12 can include a first bridge of switching devices, such as full bridge arrangement of switching transistors, and the output switching bridge 14 can include a second bridge of switching devices, such as another full bridge arrangement of switching transistors. As described in further detail below, the transistors in the switching bridges 12 and 14 can be driven with complimentary control signals, to direct the power flow between the two sides of the DCX 10, in either direction. Power flow in the DCX 10 can be directed by phase-shifting the drive control signals of the switching bridges 12 and 14 with respect to each other using phase shift modulation, for example.

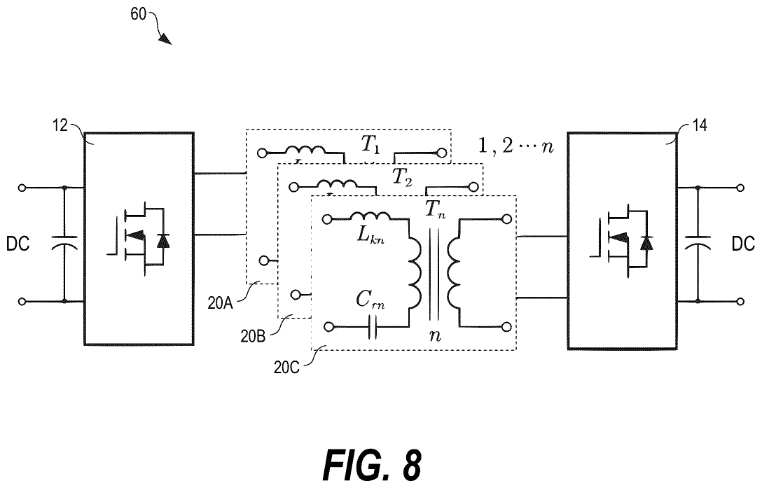

The transformer 20 includes primary and secondary windings, as would be understood in the field, for galvanic isolation between the two sides of the DCX 10. The transformer 20 also includes a resonant tank, which is provided by a capacitor Cᵣ and an inductor Lₖ, which is relied upon for (and permits) the SRC-based operation of the DCX 10. The inductor Lₖ can be embodied by the leakage inductance of the transformer 20 in some cases. As described with reference to FIG. 8 in the '353 application, the transformer 20 can be parallelized in the DCX 10 to achieve higher power operation and increased power density. However, paralleling transformers in the DCX 10 can be challenging, because even a small tolerance or difference between the resonant tanks among the transformers will lead to current-sharing issues among the paralleled transformers. Thus, the transformer 20 can be implemented as an RC EET to provide certain benefits, particularly when the DCX 10 includes paralleled transformers. Coupling of the resonant capacitor Cᵣ is then electronically-controlled.

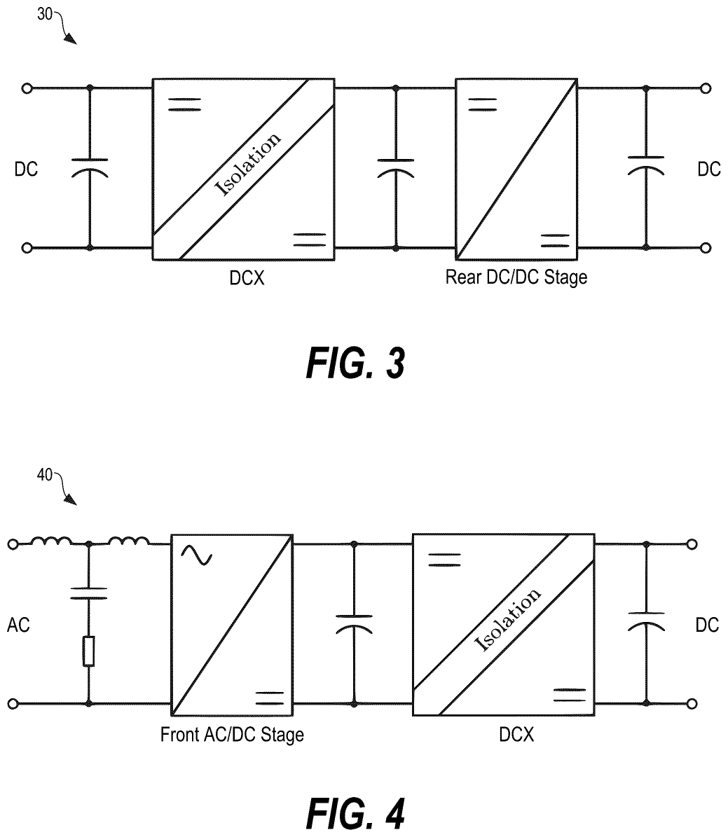

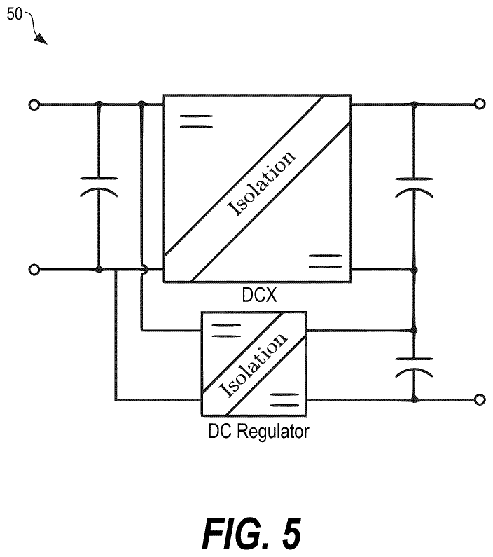

Other power converter configurations including DCX converters can include additional stages. As examples, FIGS. 3-5 illustrate DCX converters with additional stages for voltage regulation. FIG. 3 illustrates a converter 30 with a front-end DCX stage and a rear-end regulated DC/DC converter stage. The rear-end DC/DC converter stage can provide a regulated output voltage, for example, or other regulation in the power conversion of the converter 30. FIG. 4 illustrates a converter 40 with a front-end AC/DC converter stage and a rear-end DCX converter stage. The front-end AC/DC converter stage can provide AC/DC conversion, a regulated voltage for the DCX converter stage, or other conversion or regulation in the converter 40. FIG. 5 illustrates a converter 50 in a quasi-parallel configuration. The converter 50 connects a DCX converter and a DC regulator converter in series. A benefit of the converter 50 is the ability to achieve higher conversion efficiency by sharing or distributing the input power between the DCX converter and the DC regulator converter.

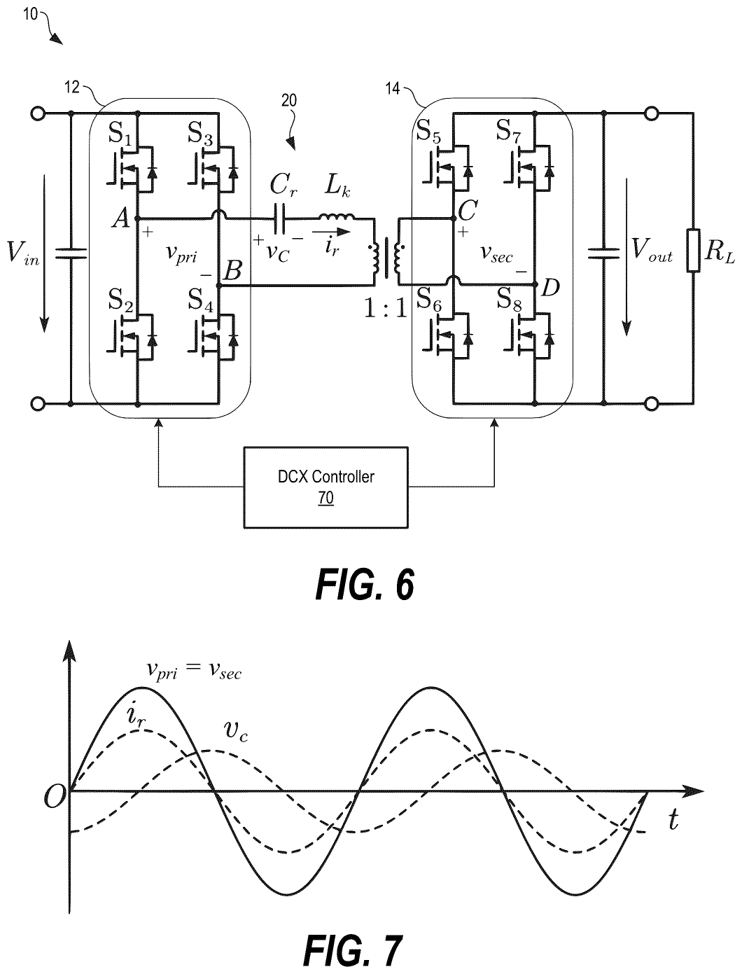

FIG. 6 illustrates a more detailed schematic diagram of the DCX 10 shown in FIG. 2. The DCX 10 is an example of an SRC-based DCX, to be distinguished from the EET-DCX power converters described in the '353 application and also from the RC EET-DCX power converters described herein. As shown, the first or input switching bridge 12 includes switching devices S₁-S₄ arranged in a full bridge, and the second or output switching bridge 14 includes switching devices S₅-S₈ arranged in a full bridge. The DCX 10 also includes a DCX controller 70. The switching devices S₁-S₄ and S₅-S₈ can be embodied as switching transistors, such as insulated-gate bipolar transistors or other suitable transistors. The switching devices S₁-S₄ and S₅-S₈ can be embodied in WBG semiconductor materials, such GaN and silicon carbide SiC semiconductor materials.

The DCX controller 70 can be embodied as processing circuitry, including memory, configured to control the operation of the DCX 10, with or without feedback. The DCX controller 70 can be embodied as any suitable type of controller, such as a proportional integral derivative (PID) controller, a proportional integral (PI) controller, or a multi-pole multi-zero controller, among others, to control the operations of the DCX 10. The DCX controller 70 can be realized using a combination of processing circuitry and referenced as a single controller. It should be appreciated, however, that the DCX controller 70 can be realized using a number of controllers, control circuits, drivers, and related circuitry, operating with or without feedback.

In some cases, the DCX controller 70 can receive a metric or measure of one or more of the input voltage Vᵢₙ, the input current, the output voltage Vₒ, the output current or power provided to the load R_{L}, the resonant converter operating frequency fs, or other operating metrics of the DCX 10 as inputs, along with external control inputs. The DCX controller 70 is configured to generate switching control signals for the switching devices S₁-S₄ and S₅-S₈ at a switching frequency fₛ. The switching control signals direct the operation of the switching devices S₁-S₄ and S₅-S₈ to transfer power between the input and the output of the DCX 10. In one example, the switching devices S₁, S₄, S₅, and S₈ can share a first control signal provided by the DCX controller 70, and the switching devices S₂, S₃, S₆, and S₇ can share a second control signal provided by the DCX controller 70, where the first and second control signals have complimentary “on” and “off” timings. The DCX controller 70 can generate the switching control signals based, at least in part, on the feedback metrics of the DCX 10, although the DCX 10 can also operate with open loop control in some cases. The duty cycle of the switching control signals can be varied by the DCX controller 70 to direct the transfer of power by the DCX 10.

The transformer 20 in the DCX 10 includes a resonant capacitor Cᵣ and an inductor Lₖ. The inductor Lₖ can be embodied as the leakage inductance of the transformer 20, as one example, or as a separate inductor. The resonant capacitor Cᵣ can be embodied as a parasitic capacitance of the transformer 20 or as a separate capacitor. Due to the presence of the resonant capacitor Cᵣ and inductor Lₖ in the DCX 10, the currents iₚᵣᵢ and i_{sec} through the primary and secondary sides of the transformer 20 are both sinusoidal waveforms. The resonant frequency fᵣ of DCX 10 can be derived as:

[symbol]

. (1)

When the DCX 10 is operating at the resonant frequency fᵣ, the primary and secondary side voltages vₚᵣᵢ and v_{sec} and the current iᵣ through the resonant tank of the transformer 20 are in phase, as shown in FIG. 7. When DCX 10 operates at a switching frequency fₛ that is equal to the resonant frequency fᵣ, the impedances produced by Cᵣ and Lₖ will cancel each other, and the equivalent impedance on the loop will be very small and close to 0. Additionally, the sinusoidal voltage v_{C} across Cᵣ has a 90° phase shift delay with respect to the primary and secondary side voltages vₚᵣᵢ and v_{sec}, as also shown in FIG. 7. In this situation, power can be transferred by the DCX 10 at high efficiency, with load-independent voltage gain, and ZVS operation.

However, even a relatively small change in the values of Cᵣ and Lₖ will shift the resonant frequency fᵣ of the DCX 10. Without a corresponding change in the switching frequency fₛ, the impedance on the power transfer loop in the transformer 20 will increase relatively dramatically and the DCX 10 cannot operate with optimal power transfer. This mismatch will result in load-dependent voltage transfer gain, as opposed to load-independent voltage gain, and efficiency deterioration for the DCX 10.

FIG. 8 illustrates an example of a DCX 60 with parallel transformers 20A-20C according to aspects of the embodiments. The DCX 60 is similar to the DCX 10 shown in FIGS. 1, 2, and 6, but the DCX 60 includes a parallel arrangement of n transformers 20A-20C between the input switching bridge 12 and the output switching bridge 14. The parallel arrangement of the transformers 20A-20C can be relied upon to increase the power handling capacity and density of the DCX 60 as compared to the DCX 10.

Paralleling the transformers 20A-20C is challenging in SRC-based DCX converters, however. Even when the transformers 20A-20C are each manufactured according to the same design, small differences in the resonant tanks among the transformers 20A-20C will lead to current-sharing disparities among the parallel transformers 20A-20C. The differences in the resonant tanks can be attributed to variations among the Lₖ inductances, Cᵣ capacitances, and other parasitic, mechanical, and electrical differences among the transformers 20A-20C due to manufacturing tolerances. Additionally, the Lₖ inductances, Cᵣ capacitances, and other electrical characteristics of the resonant tanks can vary based on differences in the operating temperatures among the transformers 20A-20C and other factors. The differences in the resonant tanks also makes it particularly difficult to operate the DCX 60 at a switching frequency fₛ that matches to a combined resonant frequency fᵣ of the parallel transformers 20A-20C.

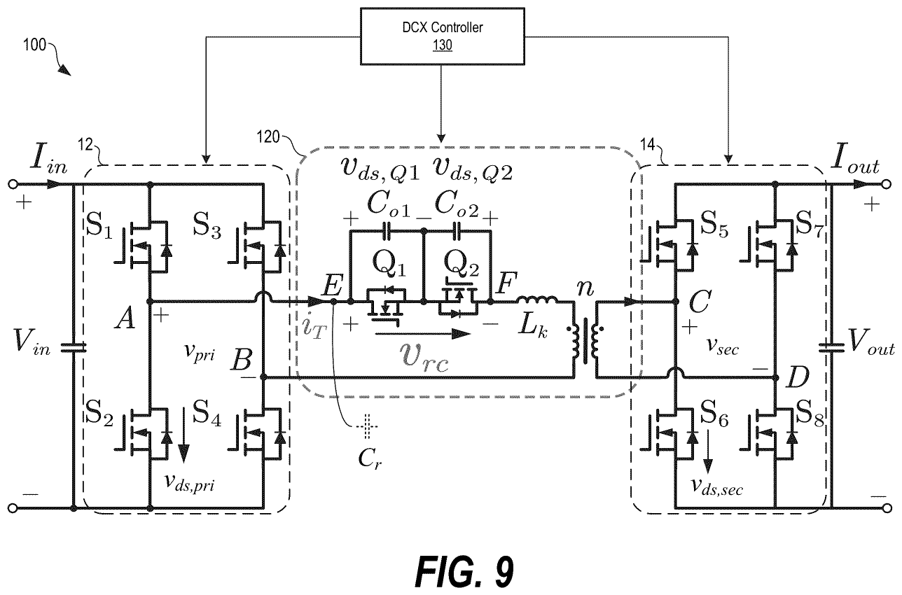

To address the current-sharing issues in the DCX 60 and provide a better solution for DCX converters capable of higher power handling capacity and power density, the DCX-based power converter embodiments described herein include RC EETs. FIG. 9 illustrates an example of a DCX power converter 100 with an RC EET 120 according to aspects of the embodiments. The DCX 100 includes the first or input switching bridge 12, the second or output switching bridge 14, the RC EET 120, and a DCX controller 130. For including the RC EET 120, the DCX power converter 100 can also be referred to herein as an RC EET-DCX (“RC EET-DCX 100”).

The RC EET-DCX 100 is illustrated as a representative example. The RC EET-DCX 100 can vary as compared to that shown. For example, the RC EET-DCX 100 can include other components that are not illustrated in FIG. 9, and the RC EET-DCX 100 can omit one or more of the components that are illustrated in FIG. 9. The switching devices, transformers, controllers, and other components in the RC EET-DCX 100 can be embodied as described below or using other suitable devices (e.g., other types of transistors, transformers, controllers, etc.), as the RC EET-DCX 100 is not limited to being implemented with any particular type or style of electronic components.

As shown, the first or input switching bridge 12 includes switching devices S₁-S₄, and the second or output switching bridge 14 includes switching devices S₅-S₈. The RC EET 120 includes a primary winding, a secondary winding, a resonant inductor Lₖ, and a bidirectional coupling switch bridge in series with the resonant inductor Lₖ. The bidirectional coupling switch bridge of the RC EET-DCX 100 includes switching devices Q₁ and Q₂ and capacitors Cₒ₁ and Cₒ₂. In the RC EET-DCX 100, the RC EET 120 replaces the transformer 20 of the DCX 10 shown in FIG. 6. Thus, the RC EET 120 is similar to the transformer 20 of the DCX 10 but also includes the bidirectional coupling switch bridge.

Because the RC EET 120 replaces the transformer 20 of the DCX 10 shown in FIG. 6, the resonant capacitor Cᵣ of the transformer 20 is not shown in FIG. 9. Instead, the capacitors Cₒ₁ and Cₒ₂ provide a substitute for the resonant capacitor Cᵣ. However, in some cases, the inductance of the resonant inductor Lₖ can be relatively large (e.g., in some wireless charging applications, etc.). Thus, in some embodiments, the RC EET-DCX 100 can also include an additional resonant capacitor Cᵣ coupled in series with the bidirectional coupling switch bridge. The additional resonant capacitor Cᵣ can be coupled in series with the switching devices Q₁ and Q₂ and capacitors Cₒ₁ and Cₒ₂, such as in series between the nodes or point “A” and “E” as shown in FIG. 9. For large values of Lₖ, the additional Cᵣ can cancel part of the inductance of the resonant inductor Lₖ, and the capacitors Cₒ₁ and Cₒ₂ can cancel the remaining inductance of the resonant inductor Lₖ.

FIG. 9 also identifies Vᵢₙ and Vₒᵤₜ, which denote the input and output voltages for the RC EET-DCX 100, respectively, and Iᵢₙ and Iₒᵤₜ, which denote the input and output currents for the RC EET-DCX 100, respectively. Additionally, vₚᵣᵢ corresponds to the voltage across the A and B nodes in the input switching bridge 12, and v_{sec} corresponds to the voltage across the C and D nodes in the output switching bridge 14. The drain-to-source voltage across Q₁ is denoted as v_{ds,Q1}, and the drain-to-source voltage across Q₂ is denoted as v_{ds,Q2}. The voltage v_{rc} denotes the output voltage across the bidirectional coupling switch bridge or the output resonant voltage across point E and F in FIG. 9, and its peak value is v_{rc,peak}. Lₖ can be embodied as the leakage inductance of the transformer in the RC EET 120, and i_{T} represents the current flowing through the RC EET 120. The magnetizing inductance in the RC EET 120 is disregarded as it exclusively pertains to the ZVS of the switching bridges 12 and 14 and is unrelated to the ZVS of the bidirectional coupling switch bridge in the RC EET 120.

The bidirectional coupling switch bridge includes switching devices Q₁ and Q₂ and capacitors Cₒ₁ and Cₒ₂. The switching devices Q₁ and Q₂ are arranged as a bidirectional switch in series with the resonant inductor Lₖ. The switching devices Q₁ and Q₂ can be embodied as switching transistors and, in some cases, can be embodied as a monolithic bidirectional switch. In some cases, the capacitors Cₒ₁ and Cₒ₂ can be embodied as the body capacitances of the switching devices Q₁ and Q₂. In other cases, Cₒ₁ and Cₒ₂ can be embodied as capacitors separate from the switching devices Q₁ and Q₂, or Cₒ₁ and Cₒ₂ can be embodied as a combination of the body capacitances of the switching devices Q₁ and Q₂ and capacitors separate from the switching devices Q₁ and Q₂. Because the voltages present across the switching devices Q₁ and Q₂ are lower than the voltages present across the switching devices S₁-S₈, the switching devices Q₁ and Q₂ can be much smaller and integrated as part of the design of the RC EET 120 as a module. The switching devices Q₁ and Q₂ can be operated based on drive control signals provided to the gates of the switching devices Q₁ and Q₂ from the DCX controller 130.

In the bidirectional coupling switch bridge, Cₒ₁ and Cₒ₂ are two symmetric parallel capacitors, such that Cₒ₁=Cₒ₂. The voltage v_{rc} denotes the output resonant voltage across point E and F in FIG. 9 and follows the following expression:

$${v}_{r c} = {Q}_{1} \cdot {v}_{d s , Q 1} - {Q}_{2} \cdot {v}_{d s , Q 2} ( {Q}_{1 ( 2 )} = 0 OFF / 1 ON ) . \qquad ( 1 )$$

In the steady state, the relationship between Vᵢₙ and Vₒᵤₜ, Iᵢₙ and Iₒᵤₜ, and vₚᵣᵢ and v_{sec} can be given in Eq. (2) as:

$$\{ \begin{matrix}{V}_{i n} = n \cdot {V}_{o u t} \\ {I}_{i n} = {I}_{o u t} / n \\ {v}_{pri} = n \cdot {v}_{s e c}\end{matrix} . \qquad ( 2 )$$

The DCX controller 130 can be embodied as processing circuitry, including memory, configured to control the operation of the RC EET-DCX 100, with or without feedback. The DCX controller 130 can be embodied as any suitable type of controller, such as a PID controller, a PI controller, or a multi-pole multi-zero controller, among others, to control the operations of the RC EET-DCX 100. The DCX controller 130 can be realized using a combination of processing circuitry and referenced as a single controller. It should be appreciated, however, that the DCX controller 130 can be realized using a number of controllers, control circuits, drivers, and related circuitry.

In some cases, the DCX controller 130 can receive a metric or measure of one or more of the input voltage Vᵢₙ, the input current Iᵢₙ, the output voltage Vₒ, output current Iₒᵤₜ or power provided to a load R_{L} (not shown in FIG. 9), the voltage v_{C} across the output of the coupling switch bridge 120, the operating frequency f_{S}, or other operating metrics of the RC EET-DCX 100 as inputs, along with external control inputs.

The DCX controller 130 is configured to generate gate drive or switching control signals for the switching devices S₁-S₄ and S₅-S₈ at a switching frequency fₛ. The switching control signals direct the operation of the switching devices S₁-S₄ and S₅-S₈ to transfer power between the input and the output of the RC EET-DCX 100. The DCX controller 130 is also configured to generate gate drive control signals for the switching devices Q₁ and Q₂ in the bidirectional coupling switch bridge, as described below.

In one example, the switching devices S₁, S₄, S₅, and S₈ in the switch bridges 12 and 14 can share a first control signal provided by the DCX controller 130, and the switching devices S₂, S₃, S₆, and S₇ in the switch bridges 12 and 14 can share a second control signal provided by the DCX controller 130, where the first and second control signals have complimentary “on” and “off” timings. The DCX controller 130 can generate the switching control signals based, at least in part, on the operating metrics of the RC EET-DCX 100, as feedback, although the RC EET-DCX 100 can also operate with simple open loop control. The duty cycle of the switching control signals can be varied by the DCX controller 130 in some cases to direct the amount of power transferred by the DCX 10.

The DCX controller 130 can also generate drive control signals for the switching devices Q₁ and Q₂ in the bidirectional coupling switch bridge. The EET-DCX described in the '353 application includes a coupling switch bridge. The switching devices Q₂ and Q₃ in the coupling switch bridge of the EET-DCX share a first phasing drive control signal provided by a DCX controller, and the switching devices Q₁ and Q₄ share a second phasing drive control signal provided by the DCX controller, where the first and second phasing drive control signals have complimentary “on” and “off” timings. In that implementation, the EET-DCX is operated with triangular transformer currents with a higher rms value as compared to the sinusoidal currents in LLC or CLLC-based DCX converters.

In the embodiments described herein, the DCX controller 130 is configured to generate drive control signals for the switching devices Q₁ and Q₂ in the RC EET 120 for quasi-trapezoidal current modulation. Through the implementation of quasi-trapezoidal current modulation using the bidirectional coupling switch bridge according to the embodiments, RC EET-DCX power converters can effectively reduce rms currents as compared to when triangular current modulation is used. The use of quasi-trapezoidal current modulation can reduce rms currents as compared to the triangular transformer currents described in the '353 application. The quasi-trapezoidal current modulation techniques described herein contribute to a reduction of total conduction loss, including reduced switching losses in the LV switching devices Q₁ and Q₂ and reduced switching losses in the HV switching devices S₁-S₄ and S₅-S₈ of the switching bridges 12 and 14. The proposed quasi-trapezoidal current modulation techniques also retain the advantages of natural current sharing, optimal operation at any frequency, load-independent voltage gain, simple open-loop control, full load range ZVS, and other benefits.

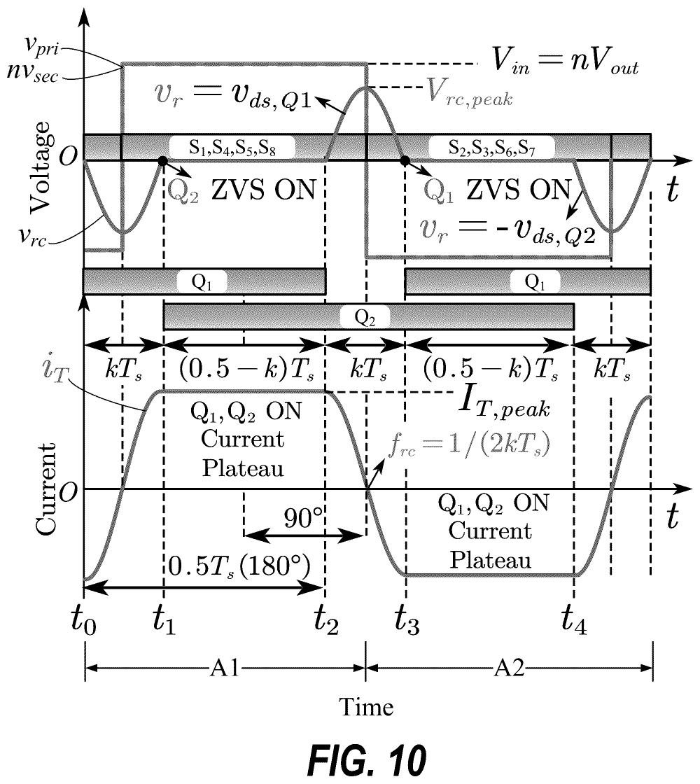

FIG. 10 illustrates example control timings for the RC EET-DCX 100 shown in FIG. 9, as generated by the DCX controller 130. As shown, both the switching bridges 12 and 14 have the same driving signals, which ensures that vₚᵣᵢ is in phase of v_{sec}. More particularly, the DCX controller 130 is configured to generate gate switching control signals to turn the switching devices S₁, S₄, S₅, and S₈ on during the time period A1 and off during the time period A2. The DCX controller 130 is also configured to generate gate switching control signals to turn the switching devices S₂, S₃, S₆, and S₇ on during the time period A2 and off during the time period A1.

The DCX controller 130 is also configured to generate gate drive control signals for the switching devices Q₁ and Q₂ in the bidirectional coupling switch bridge of the RC EET 120. The gate drive control signals of the switching devices Q₁ and Q₂ both have a 1-k duty cycle, and they have a 180-degree (half cycle) phase shift. Compared to the gate switching control signals for the switching bridges 12 and 14, the gate drive control signal for Q₁ leads a 90-degree phase shift as compared to the gate switching control signals for the switching devices S₁, S₄, S₅, and S₈ Similarly, the gate drive control signal for Q₂ leads a 90-degree phase shift as compared to the gate switching control signals for the switching devices S₂, S₃, S₆, and S₇. Based on this driving logic provided by the DCX controller 130 and Eq. (2), it can be observed that when vₚᵣᵢ equals nv_{sec}, only the voltage v_{rc} will be utilized to drive Lₖ, resulting in the generation of a quasi-trapezoidal current waveform as shown in FIG. 10. In a half cycle (e.g., from t₀ to t₂), during the current commutation from t₀ to t₁ (kTₛ), only one switch Q₁ is on, and Cₒ₂ will resonate with Lₖ at frequency f_{rc}, as:

$${f}_{r c} = \frac{1}{2 π \sqrt{{L}_{k} {C}_{o 1 ( 2 )}}} . \qquad ( 3 )$$

If Lₖ and Co/Cₒ₂ can be designed to resonate a half cycle during kTₛ, another relationship between f_{rc} and fₛ can be given as:

$${f}_{r c} = \frac{1}{2 k} \cdot {f}_{s} k ∈ ( 0 , 0.5 ] . \qquad ( 4 )$$

If the resonant frequency f_{rc} is designed or set based on Eqs. (3) and (4), this half-cycle resonance between Cₒ₁/Cₒ₂ and Lₖ can be utilized to realize transformer current commutation during t₀-t₁ or t₂-t₃ as shown in FIG. 10. As for the “current plateau” period from t₁ to t₂ ((0.5−k)Tₛ), both Q₁ and Q₂ are on, and v_{rc} is equal to 0. Due to no voltage across Lₖ, the transformer current i_{T} is flat as shown in FIG. 10. Moreover, the ZVS turn-on for Q₁ and Q₂ will be achieved at the end of resonance (t₁ or t₃) because v_{ds,Q2} and v_{ds,Q1} will drop to zero. This is distinguished from the EET-DCX described in the '353 application, which requires a full bridge to realize current commutation, and the RC EET-DCX power converter current commutation only requires one bidirectional switch.

Thus, the DCX controller 130 is configured to generate gate drive control signals for the switching devices Q₁ and Q₂ in the bidirectional coupling switch bridge to achieve a quasi-trapezoidal current i_{T}. Compared to the control signals for the switching bridges 12 and 14, the gate drive control signal for Q₁ leads a 90-degree phase shift as compared to the switching control signals for the switching devices S₁, S₄, S₅, and S₈ Similarly, the gate drive control signal for Q₂ leads a 90-degree phase shift as compared to the switching control signals for the switching devices S₂, S₃, S₆, and S₇. With this 90-degree phase shift, the bidirectional coupling switch bridge can cancel the impedance produced by the leakage inductance Lₖ by the coupling of the voltage v_{rc} voltage in series with the leakage inductance Lₖ, at any switching frequency fₛ.

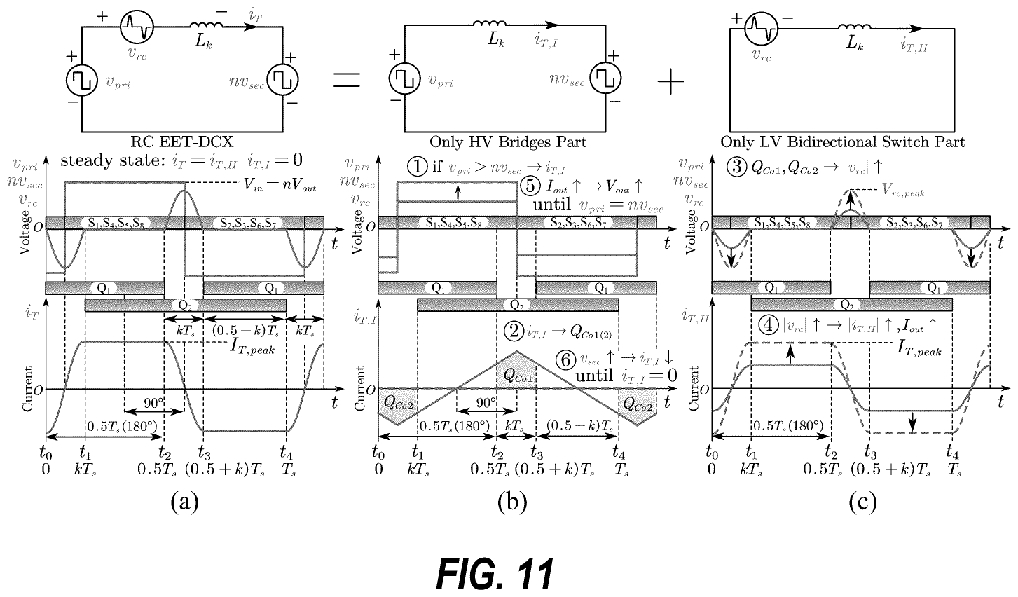

To illustrate the robust independent voltage gain of the RC EET-DCX 100, FIG. 11 shows a procedure with a certain load. Based on the superposition principle, the RC EET-DCX 100 shown in FIG. 9 can be decomposed of two parts, including the HV switching bridges 12 and 14 and the LV bidirectional coupling switch bridge in the RC EET 120. The operation principle of the robust load-independent voltage gain can be explained as six steps.

In step 1, assuming Vᵢₙ is larger than nVₒᵤₜ as shown in (b) of FIG. 11, the voltage difference (Vᵢₙ−nVₒᵤₜ) will be applied to Lₖ directly, and the triangular current i_{T,I} will have a 90-degree phase shift from vₚᵣᵢ or v_{sec}. Due to this 90-degree phase shift, there is no real power delivered to the receiving side by i_{T,I}. In step 2, since the current i_{T,I} in (b) of FIG. 11 is in phase of the voltage v_{C} (c) of FIG. 11, it will charge the capacitors Cₒ₁ and Cₒ₂ alternatively. For example, from t₀ to t₁, the current i_{T,I} keeps negative as shown in (b), and at the same time only LV switch Q₁ is ON (Q₂ is OFF). Therefore, the electric charge Q_{Co2} will be charged to Cₒ₂. As for another half period from t₂ to t₃, a positive i_{T,I} will generate Q_{Co1} to charge the capacitor Cₒ₁. In one cycle, Q_{Co1} will be equal to Q_{Co2} and always keeps the waveform v_{rc} positive and negative symmetric.

In step 3, if Vᵢₙ is larger than Vₒᵤₜ, Q_{Co1} and Q_{Co2} generated from the current i_{T,I} will always increase amplitude of v_{rc} during the whole period, as:

$${i}_{T , I} \to {Q}_{Co 1} , {Q}_{Co 2} \to \vert {v}_{r c} \vert ↑ . \qquad ( 5 )$$

In step 4, as depicted in (c) of FIG. 11, with only one voltage source excitation v_{rc}, the current i_{T,II} is quasi-trapezoidal and can be derived as:

$${i}_{T , I I} ( t ) = \{ \begin{matrix}- {I}_{T , peak} \cdot cos ( 2 π {f}_{rc} \cdot t ) & t ∈ [ 0 , {kT}_{s} ] \\ {I}_{T , peak} & t ∈ [ {kT}_{s} , 0.5 {T}_{s} ]\end{matrix} , \qquad ( 6 ) .$$

where I_{T,peak} is the peak value of i_{T}, and the range of k is from 0 to 0.5. With an increase of v_{rc} from Eq. (5), the amplitude of current i_{T,II} will become larger as shown in (c) of FIG. 11. On the other hand, the power P_{T,II} delivered to the receiving side by i_{T,II} can be given as:

$${P}_{T , I I} = {\int }_{0}^{{T}_{s}} n \cdot {v}_{s e c} ( t ) \cdot {i}_{T , I I} ( t ) . \qquad ( 7 ) .$$

Since v_{sec} is always in phase of i_{T,II}, with a larger i_{T,II} shown in the dash line, more real power P_{T,II} will be delivered to the receiving side.

In step 5, if the receiving power increases with a certain load, the corresponding output voltage Vₒᵤₜ will increase until nVₒᵤₜ is equal to Vᵢₙ, as:

$${I}_{o u t} ↑ \to {V}_{o u t} ↑ , \vert {v}_{s e c} \vert ↑ until n \cdot {V}_{o u t} = {V}_{i n} . \qquad ( 8 )$$

In step 6, assuming Vᵢₙ is constant, an increasing Vₒᵤₜ will lead to a smaller current i_{T,I} until nVₒᵤₜ is equal to Vᵢₙ.

The overall operation of the RC EET-DCX 100 with the RC EET 120, as shown in FIG. 11, can be expressed in Eq. (9) as:

$$\{ \begin{matrix}{V}_{i n} > n {V}_{o u t} & {i}_{T , I I} \to \vert {v}_{r c} \vert ↑ \to {I}_{o u t} ↑ \to {V}_{o u t} ↑ \\ {V}_{i n} = n {V}_{o u t} & {i}_{T , I I} = 0 \to const {V}_{r c , p e a k} , {I}_{T , p e a k} , {I}_{o u t} , {V}_{o u t} \\ {V}_{in} < n {V}_{o u t} & {i}_{T , I I} \to \vert {v}_{r c} \vert ↓ \to {I}_{o u t} ↓ \to {V}_{o u t} ↓\end{matrix} . \qquad ( 9 )$$

When nVₒᵤₜ is equal to Vᵢₙ, the current i_{T,I} will be equal to zero, and the peak voltage and current values V_{rc,peak} and I_{T,peak} should keep as constant, which means the RC EET-DCX 100 has entered the steady state. This analysis is based on Vᵢₙ being larger than nVₒᵤₜ. On the contrary, if Vᵢₙ is smaller than nVₒᵤₜ, with the similar analysis from Eq. (4)-(8), i_{T,II} will discharge the capacitors Cₒ₁ and Cₒ₂ during t₀-t₁ and t₂-t₃ alternatively and lead to a drop of the output current Iₒᵤₜ. With a certain load, a smaller Iₒᵤₜ will decrease Vₒᵤₜ until Vᵢₙ is equal to nVₒᵤₜ.

At the steady state, with turns ratio n, the input voltage Vᵢₙ should be equal to nVₒᵤₜ based on the analysis in Eq. (9). Therefore, as in the EET-DCX described in the '353 application, the proposed RC EET-DCX also maintains the robust load-independent voltage gain from Eq. (2).

As for the current i_{T}, component i_{T,I} should be equal to 0 at the steady state, otherwise this current will continue generate Q_{Co1} and Q_{Co2} as shown in (b) of FIG. 11. Therefore, the current i_{T} in steady state should be equal to i_{T,II}, as follows:

$$\{ \begin{matrix}{i}_{T , I} = 0 \\ {i}_{T} = {i}_{T , II}\end{matrix} . \qquad ( 10 )$$

Since this steady state is a stable equilibrium point, no extra control is required.

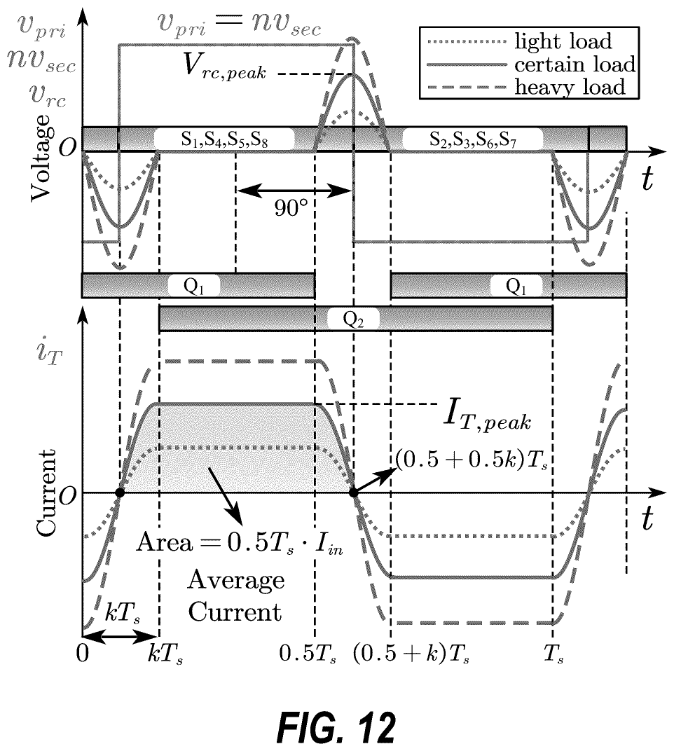

FIG. 12 illustrates steady state waveforms of the RC EET-DCX 100 shown in FIG. 9 under different load conditions. Since the transformer current i_{T} is in phase of terminal voltages vₚᵣᵢ and v_{sec} at the steady state, the transformer current i_{T} will be dedicated to real power transfer. With different loads, the amplitude of the quasi-trapezoidal current i_{T} will be regulated via v_{rc} as shown in FIG. 12. Since i_{T} is equal to i_{T,II} in the steady state, the time-domain expression of i_{T}(t) can be directly found in Eq. (6). On the other hand, the input DC current Iᵢₙ is equal to the average value of current i_{T}, as follows:

$${I}_{i n} = average current = \frac{2}{{T}_{s}} {\int }_{0.5 {kT}_{s}}^{( 0.5 + 0.5 k ) {T}_{s}} {i}_{T} ( t ) \cdot dt . \qquad ( 11 ) .$$

From Eqs. (6) and (11), the relationship between I_{T,peak} and Iᵢₙ can be given as:

$${I}_{T , peak} = \frac{π}{4 \cdot k + ( 1 - 2 \cdot k ) \cdot π} \cdot {I}_{in} . \qquad ( 12 )$$

Following Eqs. (6) and (12), the transformer rms current i_{T,rms} can also be derived as:

$$\begin{matrix}{I}_{T , rms} & = \frac{1}{{T}_{s}} \sqrt{{\int }_{0}^{{T}_{s}} {i}_{T}^{2} ( t ) dt} \\ & = \frac{\sqrt{1 - k} \cdot π}{( 1 - 2 \cdot k ) \cdot π + 4 \cdot k} \cdot {I}_{in}\end{matrix} . \qquad ( 13 )$$

As for the resonant voltage v_{cr} in the steady state, the time-domain expression of v_{cr}(t) can be given as:

$${v}_{cr} ( t ) = \{ \begin{matrix}- {V}_{cr , peak} \cdot sin ( 2 π {f}_{rc} \cdot t ) & t ∈ [ 0 , {kT}_{s} ] \\ 0 & t ∈ [ {kT}_{s} , 0.5 {T}_{s} ]\end{matrix} , \qquad ( 14 )$$

where the peak voltage value V_{cr,peak} can be derived as:

$$\begin{matrix}{V}_{cr , peak} & = {L}_{k} \cdot \frac{{di}_{T} ( t )}{dt} {\vert}_{t = ( 0.5 + 0.5 k ) {T}_{s}} \\ & = \frac{{π}^{2}}{k \cdot ( 4 \cdot k + ( 1 - 2 \cdot k ) \cdot π )} \cdot {f}_{s} \cdot {L}_{k} \cdot {I}_{in}\end{matrix} . \qquad ( 15 )$$

From Eq. (15), the peak voltage V_{rc,peak} applied on the LV bidirectional switch Q₁ and Q₂ is proportional with switching frequency fₛ, leakage inductance Lₖ, and input DC current Iᵢₙ, as follows:

$${V}_{cr , peak} ∝ {f}_{s} , {L}_{k} , {I}_{in} . \qquad ( 16 )$$

With a pre-determined Iᵢₙ, fₛ, and k, the transformer leakage inductance Lₖ should be minimized because it can reduce the voltage stress on the LV bidirectional switch. With devices having smaller voltage ratings, the bidirectional switch can be easily embedded into the RC EET 120 as a module. For instance, when Iᵢₙ is 10 A, fₛ is 200 kHz, k is 0.3, Lₖ is 300 nH, the voltage stress V_{rc,peak} on the bidirectional switch can be derived as only 8 V from Eq. (15). Notably, the voltage stress V_{rc,peak} is unrelated to input or output voltage Vᵢₙ₍ₒᵤₜ₎ from Eq. (15), which means the RC EET-DCX 100 can be adopted in high voltage applications. Even if the input and output voltages are large, a LV bidirectional switch can still be selected. Overall, since Vᵢₙ is equal to nVₒᵤₜ at the steady state, the resonant voltage v_{rc} will be directly applied to Lₖ, which means the voltage drop on Lₖ is fully compensated by this embedded LV bidirectional switch.

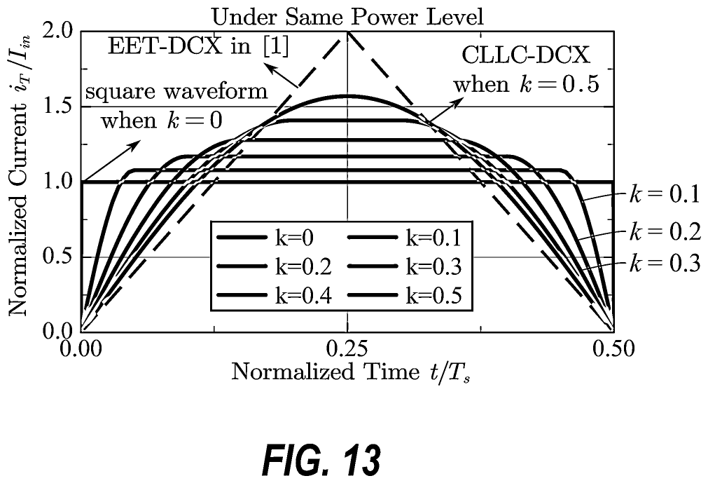

Based on the time-domain expression of i_{T}(t) from Eq. (6), FIG. 13 illustrates the normalized transformer current i_{T}/Iᵢₙ in the RC EET-DCX 100 with different commutation coefficients k. Under the same power level, the current i_{T} is normalized based on input dc current Iᵢₙ. When 0<k<0.5, the transformer current i_{T} in the RC EET 120 exhibits a quasi-trapezoidal waveform composed of two parts, including (1) a resonance part during the current commutation and (2) the “current plateau”. When k is equal to 0, the current waveform changes to the ideal square waveform. Conversely, when k is equal to 0.5, the resonant current will occupy the whole period and the “current plateau” will disappear, which means the RC EET-RC EET-DCX 100 will transition to the traditional resonant CLLC-DCX when k=0.5. Additionally, for comparison purposes, the triangular current from the EET-DCX described in the '353 application is depicted as a dashed line in FIG. 13, assuming the same power rating.

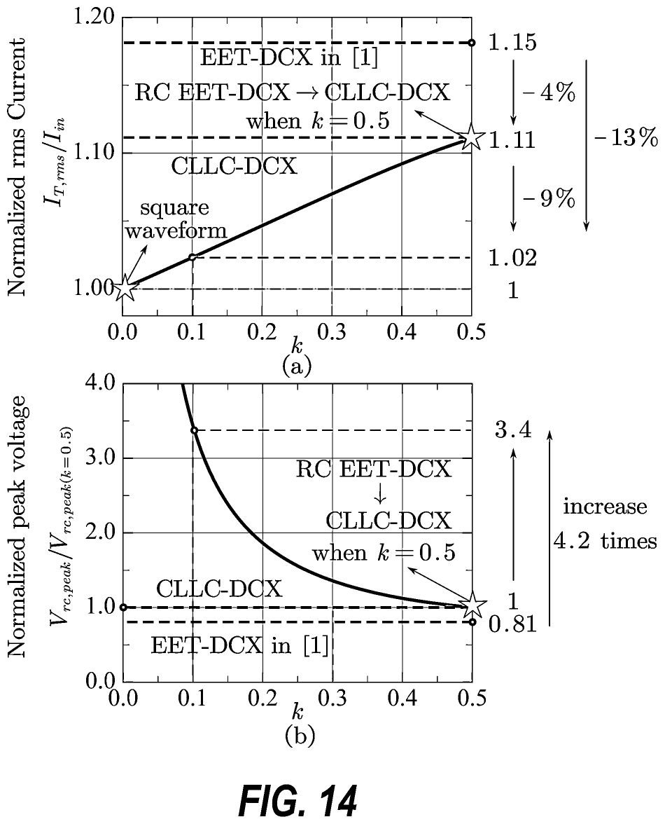

Following Eq. (13), (a) in FIG. 14 illustrates normalized rms current I_{T,rms} based on Iᵢₙ with different commutation coefficients k. Comparing it with the sinusoidal current observed in a CLLC-DCX or k=0.5 case, the rms current can be reduced by 9% and 11% for k=0.1 and 0, respectively. Notably, for k=0.1, the rms current is significantly reduced by 13% as compared to the EET-DCX described in the '353 application.

On the other hand, (b) in FIG. 14 represents the normalized peak voltage V_{rc,peak} based on V_{rc,peak} with k=0.5 from Eq. (15). One drawback of the RC EET-DCX and corresponding quasi-trapezoidal current modulation is that V_{rc,peak} increases when k decreases. Theoretically, if k can be reduced to 0, the square waveform transformer current would be optimal. However, based on Eq. (15), when k is close to 0, V_{cr,peak} will increase dramatically. For example, when k=0.1, V_{rc,peak} increases by 4.2 times as compared with the EET-DCX described in the '353 application. Thus, a trade-off exists, because when k approaches 0, the quasi-trapezoidal current becomes more like a square waveform with a smaller rms current as shown in FIG. 13, but it results in an increase in V_{rc,peak} across the bidirectional switch as shown in (b) in FIG. 14. However, in practical scenarios, V_{rc,peak} is typically very small. For example, when Iᵢₙ is 10 A, fₛ is 200 kHz, k is 0.1, Lₖ is 300 nH, the voltage stress V_{rc,peak} on bidirectional can be derived as only 20 V from Eq. (15). This indicates that the increased V_{rc,peak} is acceptable when it leads to a reduction in rms current.

The RC EET-DCX 100 with its related quasi-trapezoidal current modulation reduces the total number of active devices needed from 4 in the in the EET-DCX to 2 (e.g., if discrete Q₁ and Q₂ are used) or 1 (e.g., if a monolithic bidirectional switch is used). Additionally, the corresponding quasi-trapezoidal current can reduce the total conduction loss through a smaller rms current, when considering the total conduction loss in the HV switching bridges 12 and 14, in the LV bidirectional coupling switch bridge of the RC EET 120, and in the transformer windings of the transformer of the RC EET 120.

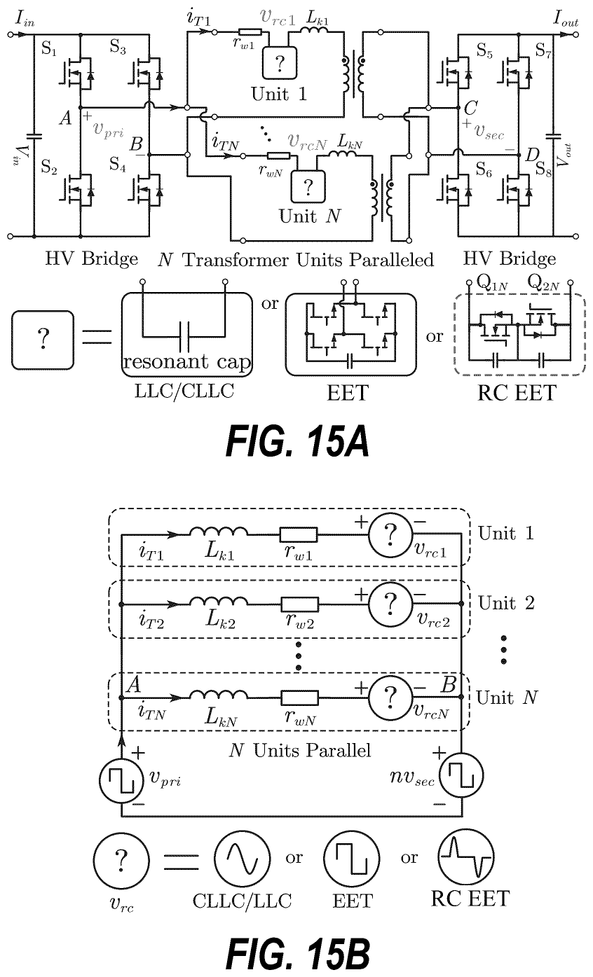

Due to higher power density, transformer-level parallel solutions are more desirable than converter-level parallel solutions when the power rating of DCX power converts are scaled up. FIG. 15A illustrates three transformer-level parallel solutions, including a CLLC-DCX parallel solution, a EET-DCX parallel solution, and an RC EET-DCX parallel solution. FIG. 15B illustrates simplified equivalent circuits for the parallel solutions shown in FIG. 15A. i_{T1-N} are the transformer currents among each paralleled unit. r_{w1-N} are the loop resistances on each parallel unit. Due to the robust load independent voltage gain from Eq. (2), the two HV bridges in FIG. 15A are replaced by two identical square voltage sources vₚᵣᵢ and nv_{sec} in FIG. 15B According to the topology solution, v_{rc1-N} can be replaced by sinewave (CLLC), square wave (EET), or part sinewave plus zero-stage waveform (RC EET). Based on Kirchoff's voltage law (KVL), the terminal voltage v_{AB} can be expressed as:

$${V}_{AB} = {jwL}_{kN} \cdot {i}_{TN} + {v}_{rcN} + {r}_{wN} \cdot {i}_{TN} ( N = 1 , 2 , 3 … ) . \qquad ( 17 )$$

The current sharing performance of CLLC-DCX and EET-DCX power converters have be illustrated in the '353 application. The current sharing performance of CLLC-DCX power converters is sensitive, particularly for tolerance on the leakage inductance Lₖ. Once the converter shifts away from the resonant point, current sharing will be very poor. The EET-DCX proposed in the '353 application has robust current sharing because the square voltage source v_{rcN} can always cancel the impedance from leakage inductance Lₖ. Therefore, current sharing will be only determined by the resistance r_{w} of each parallel transformer, which can be more easily controlled during manufacturing. The natural current sharing in EET-DCX power converters results from a constant 90-degree phase shift between v_{rc} and v_{pri(sec)}. As for the resonant CLLC-DCX, v_{rc} will have a 90-degree phase shift from v_{rc} and v_{pri(sec)} only when it exactly works at resonant point.

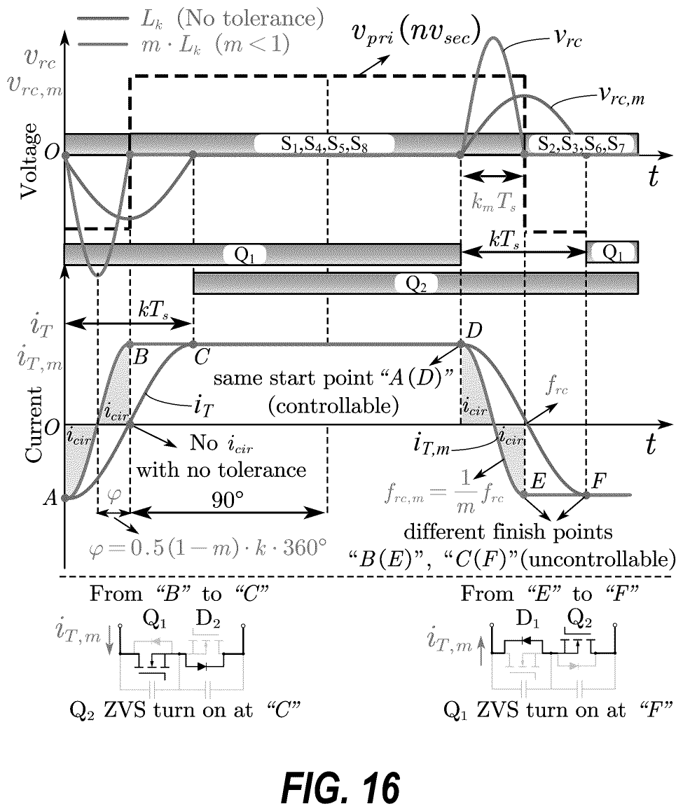

In the RC EET-DCX power converters described herein, the current sharing in converter-level parallel solutions is different than that in EET-DCX power converters, because the tolerance on Lₖ will influence the resonant commutation frequency f_{rc} from Eq. (3). To illustrate this impact, FIG. 16 illustrates the impact of the tolerance on the leakage inductance Lₖ for the RC EET-DCX 100 shown in FIG. 9. FIG. 16 illustrates cases of no tolerance on Lₖ and when Lₖ has been multiplied by a factor of m. When m<1, the real leakage inductance Lₖ is smaller than the designed value of Lₖ. With tolerance m, the resonant commutation voltage v_{rc,m} and transformer current i_{T,m} are both plotted in FIG. 16. As shown, a smaller leakage inductance mLₖ will increase the resonant commutation frequency from f_{rc} to f_{rc,m}. The relationship between f_{rc,m} and designed f_{rc} can be given as:

$${f}_{rc , m} = \frac{1}{m} \cdot {f}_{rc} , \qquad ( 18 )$$

where f_{rc} can be easily derived from Eq. (3) and (4). According to the driving signals for the bidirectional switch Q₁ and Q₂, the resonant current commutation in FIG. 16 will start at the same time point “A” and “D”, either without tolerance (Lₖ) or with tolerance (mLₖ). If there is no tolerance, the current commutation will end at points “C” and “F”. At these two time points, the bidirectional switch Q₂ and Q₁ will turn on to achieve the ZVS, respectively.

As for the case with mLₖ leakage inductance, current commutation will end earlier at time points “B” and “E”. Then, after the current commutation, from “B” to “C” and from “E” to “F”, the transformer current i_{T,m} will pass through the channel of one of the devices Q₁ or Q₂ and through the body diode D₁ or D₂ of another one of the devices Q₁ or Q₂, as shown in FIG. 16. Even with the mLₖ leakage inductance tolerance, the bidirectional switch Q₁ and Q₂ can still realize ZVS turn on. The reason is that before the devices Q₁ or Q₂ turn on at points “C” and “F”, the transformer current has gone through their body diodes. With the tolerance, a small phase different between i_{T} and i_{T,m} will occur and the circulating current i_{cir} will exist as shown FIG. 16.

If the real or actual leakage inductance Lₖ is smaller than the design value, it can be equivalent to a new situation with a small phase shift tolerance φₘ (90-degree default) and a new current commutation interval kₘTₛ, as:

$${φ}_{m} = 0.5 \cdot ( 1 - m ) \cdot k \cdot 360 ° and \qquad ( 19 )$$

$${k}_{m} = m \cdot k . \qquad ( 20 )$$

For example, if k=0.2, and Lₖ has a −20% tolerance (m=0.8), the phase shift tolerance φ is only 7.2 degree and the new kₘ is 0.16. When m is larger than 1, which means the real leakage inductance is larger than Lₖ, the bidirectional switch Q₁ and Q₂ will lose ZVS, and the current sharing performance will be disrupted because resonant current commutation cannot finish during kTₛ.

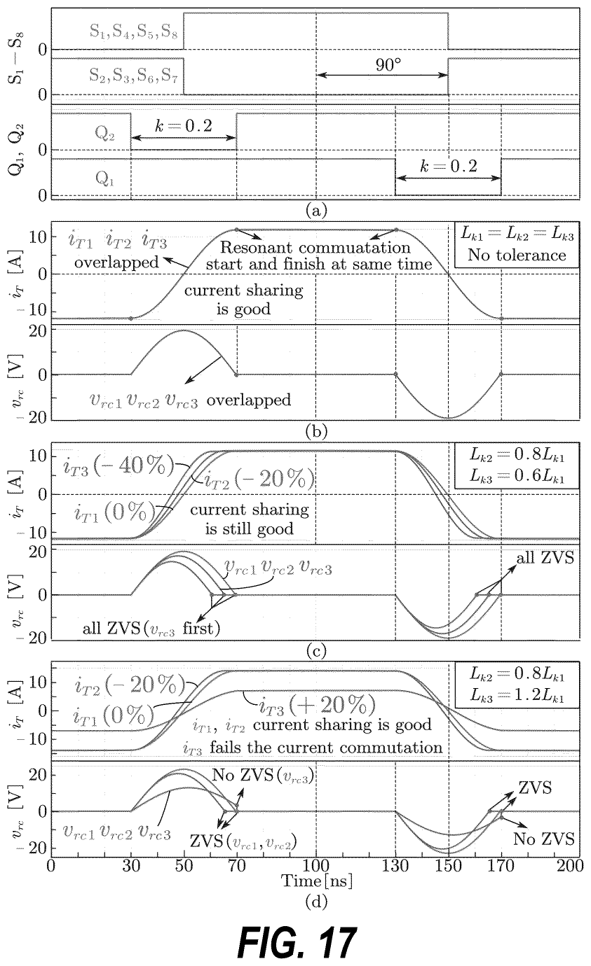

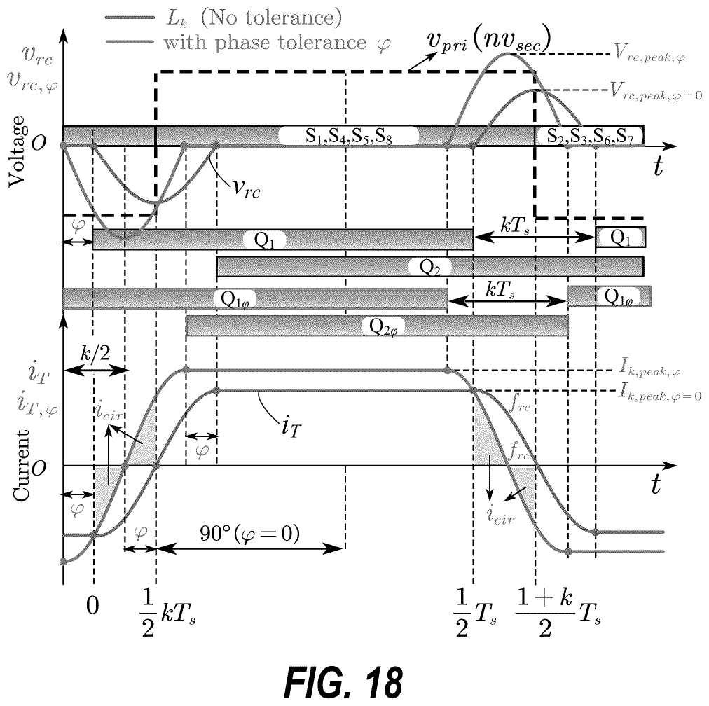

FIG. 17 illustrates simulated waveforms for the RC EET-DCX 100 with three paralleled transformers. The simulation parameters are all listed in Table I.

TABLE I
CURRENT SHARING SIMULATION PARAMETERS

| Variable | Value | Variable | Value |
|---|---|---|---|
| Input voltage Vᵢₙ | 300 V | Output voltage | 300 V |
| Parallel number N | 3 | Vₒᵤₜ | |
| Rating power P | 9 kW | Loop resistance r_{w} | 100 mΩ |
| Commutation | 0.2 | Switching | 500 kHz |
| index k | | frequency fₛ | |
| Leakage | 210 nH | RC frequency f_{rc} | 2.5 MHz |
| inductance Lₖ | | Parallel | 36.2 nF |
| | | capacitance Cₒ₁₍₂₎ | |

In FIG. 17, (a) represents the driving signals of the HV switches S₁-S₈ and the LV bidirectional switches Q₁ and Q₂. With no tolerance in the leakage inductance Lₖ among the three paralleled transformers (i.e., Lₖ₁=Lₖ₂=Lₖ₃) as shown in (b) of FIG. 17, all three current i_{T} currents overlap very well and current sharing is very good. In FIG. 17, (c) shows the case with m=0.8 (−20%) and m=0.6 (−40%) for Lₖ₂ and Lₖ₃. Based on the previous analysis in FIG. 16, although there is a small phase difference among three transformer currents i_{T1}, i_{T2}, and i_{T3}, the current sharing is still good because current commutation will start at the same point among these three cases. Finally, the larger inductance case when m>1 is depicted in (d) in FIG. 17. According to the previous analysis, if m>1, current commutation will fail, and LV bidirectional switch Q₁ and Q₂ will lose ZVS because the resonant commutation period becomes larger than kTₛ. Therefore, some margin on Lₖ should be provided for in practice to ensure that the resonant current commutation can be finished.

Since the tolerance on the leakage inductance Lₖ among paralleled transformers can be seen as a phase shift tolerance plus a changed kₘ, the phase shift tolerance is described below. FIG. 18 illustrates the impact of phase shift tolerance on the RC EET-DCX shown in FIG. 9, with a single transformer, according to aspects of the embodiments. Without the tolerance on the leakage inductance Lₖ, the driving signals for the HV switches S₁-S₈ should have an open-loop 90-degree phase shift with the LV bidirectional switch Q₁ and Q₂. However, if there is a small tolerance φ on the driving signals because of a gate driver propagation delay, the new gating signals Q_{1(2),φ} are also depicted in FIG. 18. After considering this tolerance φ, the time domain expression for transformer current i_{T,φ}(t) can be revised from Eq. (6), as follows:

$${i}_{T , φ} ( t ) = \{ \begin{matrix}{I}_{T , peak , φ} \cdot cos ( 2 π {f}_{rc} \cdot t + φ ) & t ∈ [ - φ , k - φ ] \cdot {T}_{s} \\ {I}_{T , peak , φ} & t ∈ [ k - φ , 0.5 - φ ] \cdot {T}_{s}\end{matrix} , \qquad ( 20 )$$

where I_{T,peak,φ} is the peak value of the transformer current i_{T,φ} with the tolerance. Similarly, the derivation of the I_{T,peak,φ} in FIG. 18 can follow the average current calculation as shown below:

$${I}_{in} = average current = \frac{2}{{T}_{s}} {\int }_{\frac{1}{2} {kT}_{s}}^{\frac{1 + k}{2} {T}_{s}} {i}_{T , φ} ( t ) \cdot dt . \qquad ( 21 )$$

From Eqs. (20) and (21), the relationship between I_{T,peak,φ} and Iᵢₙ can be given as:

$${I}_{T , peak , φ} = \frac{π}{( 1 - 2 k ) π + 4 k \cdot cos ( \frac{φ}{k} \cdot π )} \cdot {I}_{in} . \qquad ( 22 )$$

Following the derivation above, the corresponding peak resonant voltage value V_{rc,peak,φ} and rms current I_{T,rms,φ} can be both revised as:

$${V}_{rc , peak , φ} = \frac{{π}^{2}}{k \cdot ( ( 1 - 2 k ) π + 4 k \cdot cos ( \frac{φ}{k} π ) )} \cdot {f}_{s} {L}_{k} {I}_{in} \qquad ( 23 )$$

$$and$$

$${I}_{T , rms , φ} = \frac{\sqrt{1 - k} \cdot π}{( 1 - 2 k ) π + 4 k \cdot cos ( \frac{φ}{k} π )} \cdot {I}_{in} \qquad ( 24 )$$

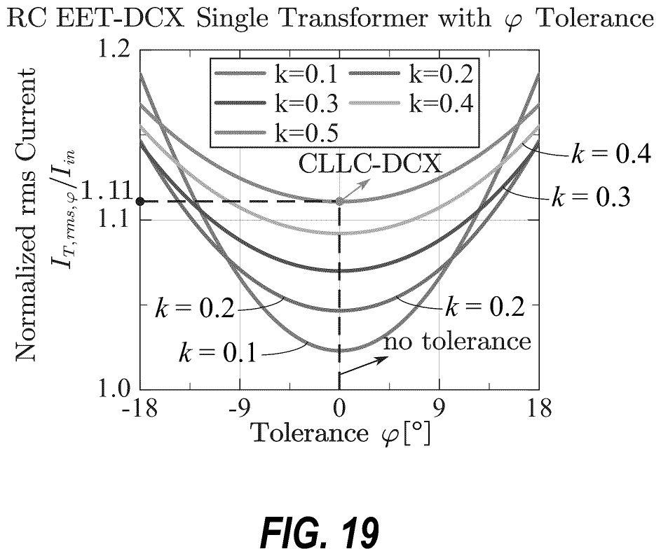

From Eq. (24), with the phase shift tolerance φ from −18 degree to +18 degree, FIG. 19 illustrates the normalized transformer current I_{T,rms,φ}/Iᵢₙ based on input DC current with different k. The dashed line in FIG. 19 shows the results with no tolerance (φ=0). When k=0.5, the normalized transformer current I_{T,rms,φ}/Iᵢₙ of the RC EET-DCX 100 will change from a quasi-trapezoidal to a pure sinusoidal current.

The tolerance on phase shift (default 90-degree) will cause a phase shift between terminal voltages v_{pri(sec)} and transformer current i_{T,φ} as shown in FIG. 18, which means there are some circulating currents and reactive power. To transfer the same real power, plus some reactive power due to the phase shift tolerance φ, the transformer rms current will be larger than the no tolerance case shown in FIG. 19.

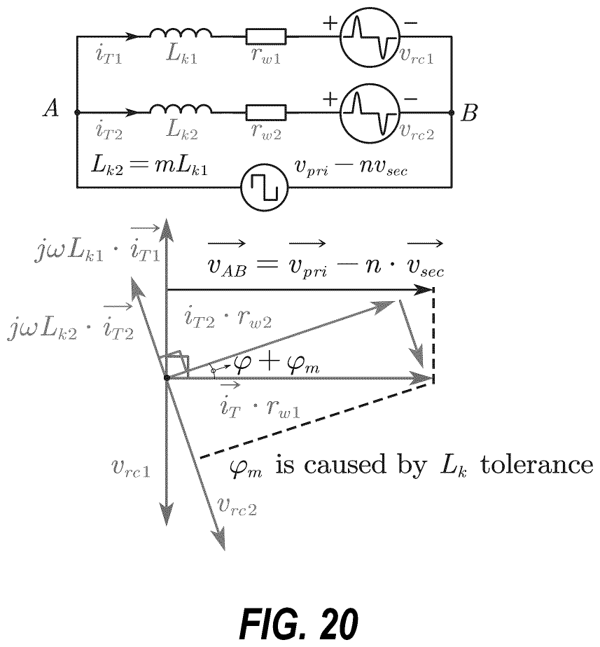

When multiple RC EETs are paralleled to scale up the power rating of an RC EET-DCX, the current sharing performance can be analyzed with the phasor diagram as shown in FIG. 20. The current i_{T1} branch has no tolerance, and current i_{T2} branch has both Lₖ tolerance and phase shift tolerance. As shown in FIG. 20, φ is related to the phase shift tolerance on gate drive signals, and φₘ is related to the phase shift tolerance caused by Lₖ tolerance. Due to the same driving signals being applied to the primary and secondary side HV switch bridges 12 and 14, vₚᵣᵢ is in phase of v_{sec}. On the other hand, in the load-independent analysis, vₚᵣᵢ is equal to nv_{sec} because the voltage drop on winding resistance has been ignored. However, in the current sharing analysis, this voltage cannot be ignored, and it results in the voltage v_{AB}, which also has the same phase as v_{pri(sec)}. Then, Eq. (17) can be converted into vector form, as follows:

$$\vec{{v}_{AB}} = \vec{{i}_{T 1}} \cdot {r}_{w 1} = \vec{{i}_{T 2}} \cdot {r}_{w 2} + \vec{{v}_{r c 2}} - j ω {L}_{k} \cdot \vec{{i}_{T 2}} . \qquad ( 25 )$$

From Eq. (25), the branch i_{T1} (without tolerance) and branch i_{T2} (with tolerance) should have the same voltage drop v_{AB} as shown in FIG. 20. Based on this geometric relationship, the current sharing relationship between i_{T1} and i_{T2} can be given as:

$$\vec{{i}_{T 2}} \cdot {r}_{w 2} = \vec{{i}_{T 1}} \cdot {r}_{w 1} \cdot cos ( φ + {φ}_{m} ) . \qquad ( 26 )$$

To generalize Eq. (26) to N transformer parallel, the current sharing can be given as:

$${i}_{T 1} : ⋯ : {i}_{T N} = \frac{1}{{r}_{w 1} cos ( {φ}_{1} + {φ}_{m 1} )} : ⋯ : \frac{1}{{r}_{w 2} cos ( {φ}_{N} + {φ}_{mN} )} , \qquad ( 27 )$$

where φ_{mN} can be found in Eq. (19). From Eq. (26), in the steady state, the transformer unit without the tolerance will take more current. The current sharing performance will be mainly determined by total loop resistance r_{w}, which has a positive temperature coefficient and can be easier controlled compared to inductance. As for the phase shift tolerance, for example, if the phase difference is 14.4-degree, the current difference will be only 3%.

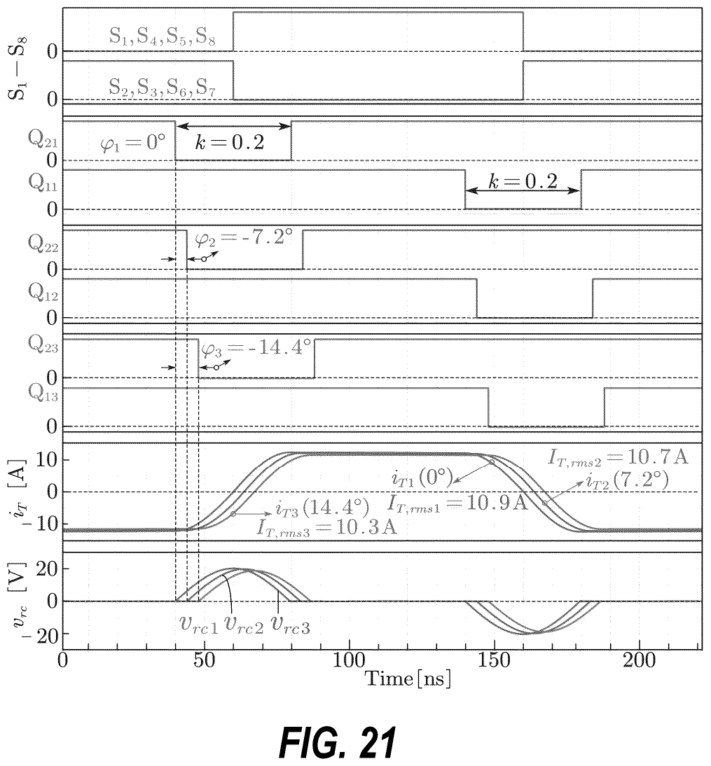

Following the same parameters listed in Table I, FIG. 21 illustrates simulated current sharing results with phase shift tolerance. Among three paralleled branches, i_{T1}, i_{T2}, and i_{T3}, the phase shift tolerance is 0, −7.2, and −14.4 degree, respectively. Due to no tolerance on Lₖ, all three currents can finish current commutation during kTₛ. A small phase difference among the three currents can be found in FIG. 21. However, the rms current for i_{T1}, i_{T2}, and i_{T3} are 10.9, 10.7, and 10.3 A, respectively, which follows the relationship from Eq. (27). The simulation results in FIG. 21 verify good current sharing among paralleled transformers in an RC EET-DCX even with phase shift tolerance. This phase shift tolerance will have the same impact on the current sharing performance of the EET-DCX described in the '353 application.

To verify the operation and merits of the RC EET-DCX designs described herein, two 12-kW DCX prototypes were reduced to practice, including a RC EET-DCX power converter and a EET-DCX power converter. The DCXs were based on one same platform, and the HV switch bridges were shared (i.e., the same) between the two prototypes. To verify current sharing performance, four modularized RC EET units were paralleled in the RC EET-DCX and four modularized EET units were paralleled in the EET-DCX. The RC EET units had the same size and the winding layout as the EET units. The parameters of the 12 kW RC EET-DCX are listed in Table II.

TABLE II
PARAMETERS OF RC EET-DCX WITH FOUR EET
UNITS

| Variable | Value | Variable | Value |
|---|---|---|---|
| Vᵢₙ₍ₒᵤₜ₎ | 300 V | Cₒ₁₍₂₎ | 22.7 nF |
| P | 12 kW | fₛ | 200 kHz |
| Lₖ | 620 nH | L_{pri(sec)} | 15 μH |
| ER Core | ECW64A18 | Core | DMR51 |
| C_{oss, pri(sec)} | 418 pF × 2 | Material | |
| HV Bridge | C3M0016120k × | C_{oss, LV} | 1310 pF |
| | 2 | LV Q₁ and | EPC 2029 |
| | | Q₂ | |

The EET units in the EET-DCX included a full LV bridge, and the RC EET units in the RC EET-DCX included an LV bidirectional switch. The same 80 V GaN device EPC 2029 was adopted for both the RC EET and EET units.

The two 12 kW DCX prototypes shared the same Silicon Carbide (SiC) based HV switch bridges on the primary and secondary sides. The only difference between the RC EET-DCX and the EET-DCX was the transformer units. With a total rating power of 12 kW with four transformer units paralleled, each transformer unit was designed for 3 KW (300 V, 10 A). Based on the parameters of Lₖ and Cₒ₁, the ideal value of k was calculated as 0.22 from Eq. (3) and (4). However, to prevent current commutation failure caused by tolerance on Lₖ among the RC EET units, a small margin should be provided for as described above, and k should be slightly larger than 0.22.

In one experiment, a small margin was left for k and the selected value for k was equal to 0.26. Due to the small margin on k, the commutation procedure finished earlier than the bidirectional switch turning on. Under full load (12 kW), a small voltage drop on v_{ds,Q1,T1} was observed after the current commutation because the transformer current went through the body diode of the bidirectional switch first and then ZVS was realized. It was found that the four transformer currents matched very well with each other, to verify the current sharing performance of the RC EET-DCX. Under half load (6 kW), the amplitude of the resonant voltage v_{ds,Q1,T1} and all transformer currents i_{T1-4} reduced by half.

Two other values of k were also evaluated. In one experiment, the value of k was selected as the ideal calculated value of 0.22. Either with full load or half load, the resonant current commutation finished when the bidirectional LV switch turns on. In this case, no current will go through the body diodes of Q₁ or Q₂, and thus there is no small voltage drop after the current commutation. However, this case will be sensitive to the Lₖ tolerance because a larger Lₖ will cause the current commutation failure, and then bidirectional switches Q₁ and Q₂ will lose ZVS. In another experiment, the value of k was selected at 0.30. Compared with k=0.26, a longer voltage drop time was observed after current commutation. This is because the transformer current goes through the body diodes of Q₁ and Q₂ over a longer time.

Overall, the experiments confirmed that there is a trade-off on the selection of k. If no margin is left for current commutation (smallest k), the RC EET-DCX converter will have efficiency-wise benefits, because no current will go through the body diodes. However, the converter will be more sensitive to Lₖ tolerance, especially a larger Lₖ. Depending on the actual Lₖ tolerance in practice, a small margin is usually given, and the final selected k will be slightly larger than the calculated value.

A 12-kW EET-DCX prototype was also built and tested. Good current sharing performance was also verified among the four EET units in the EET-DCX prototype. Compared with the quasi-trapezoidal current in the RC EET-DCX prototype, the triangular current in the EET-DCX prototype had a larger rms current, which means higher total conduction loss.

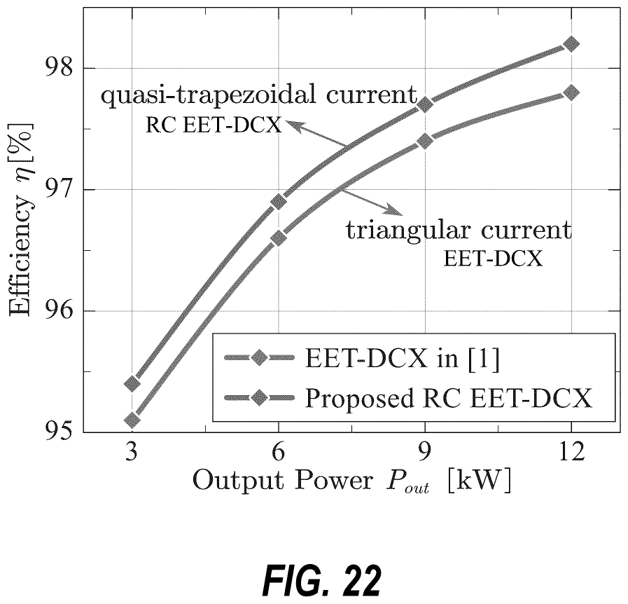

With the same 12 kW testbench (i.e., same HV switch bridges, same transformer winding layout, etc.), FIG. 22 shows the efficiency test results for both the RC EET-DCX prototype and the EET-DCX prototype. The triangular current waveform in EET-DCX exhibits a higher rms current as compared to the quasi-trapezoidal current in the RC EET-DCX. In the RC EET-DCX, this reduction in conduction loss not only applies to the transformer windings but also to the HV switch bridge devices. Thus, as compared to the EET-DCX prototype, the RC EET-DCX prototype showed a higher efficiency (e.g., 98.4% at 12 kW) over the entire load range. This efficiency benefit is particularly advantageous in high-current, high-power applications, as the additional loss on the LV bridge becomes less significant in comparison.

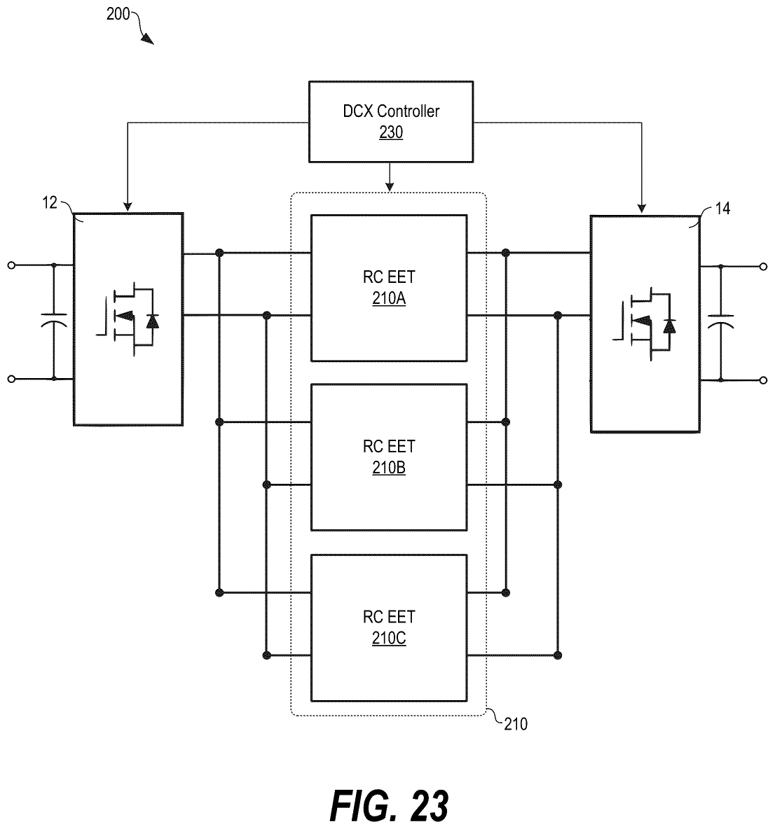

The resonant commutation and quasi-trapezoidal current modulation control techniques described herein can be extended to parallel and serial arrangements of RC EETs in a DCX converter. FIG. 23 illustrates an example of an RC EET-DCX 200 with a parallel arrangement of RC EETs according to aspects of the embodiments. The RC EET-DCX 200 is illustrated as a representative example. The RC EET-DCX 200 can vary as compared to that shown. For example, the RC EET-DCX 200 can include other components that are not illustrated in FIG. 23, such as additional RC EETs, and the RC EET-DCX 200 can omit one or more of the components that are illustrated in FIG. 23. The switching devices, transformers, controllers, and other components in the RC EET-DCX 200 can be embodied as described herein or using other suitable devices (e.g., other types of transistors, transformers, controllers, etc.), as the RC EET-DCX 200 is not limited to being implemented with any particular type or style of electronic components.

As shown, the RC EET-DCX 200 includes the first or input switching bridge 12, the second or output switching bridge 14, RC EETs 210A-210C, and a DCX controller 230. Each of the RC EETs 210A-210C is similar to the RC EET 120 shown in FIG. 9. The RC EETs 210A-210C are coupled in parallel between the first and second switching bridges 12 and 14 and, collectively, form an electronically-controlled parallel transformer 210 for high current applications. Although three RC EETs 210A-210C are shown, the RC EET-DCX 200 can include any suitable number of RC EETs depending on the desired power handling (e.g., current handling) capacity of the RC EET-DCX 200. Among possibly other components, each RC EET 210A-210C includes a bidirectional coupling switch bridge, a primary transformer winding, and a secondary transformer winding.

The DCX controller 230 can be similar to the DCX controller 130 and embodied as processing circuitry, including memory, configured to control the operation of the DCX 200. In some cases, the DCX controller 230 can receive a metric or measure of one or more of the input voltage Vᵢₙ, the input current Iᵢₙ, the output voltage Vₒ, output current Iₒᵤₜ or power provided to a load R_{L} (not shown in FIG. 23), the operating frequency fs, or other operating metrics of the RC EET-DCX 200 as inputs, along with external control inputs.

The DCX controller 230 is configured to generate drive or switching control signals for the first and second switching bridges 12 and 14 at a switching frequency fₛ. The switching control signals direct the operation of the switching bridges 12 and 14 to transfer power between the input and the output of the RC EET-DCX 200. The DCX controller 230 is also configured to generate drive control signals based on quasi-trapezoidal current modulation control for the switching devices in the bidirectional coupling switch bridge of each RC EET 210A-210C.

The RC EET-DCX 200 offers an improvement as compared to the DCX 60 shown in FIG. 8 and described above. Particularly, even if the transformers in the RC EETs 210A-210C have small differences among Lₖ inductances in the RC EETs 210A-210C, the DCX controller 230 is configured to provide drive control signals to the bidirectional coupling switch bridges in the RC EETs 210A-210C, as described herein, for current balancing among the RC EETs 210A-210C.

In the DCX 60 shown in FIG. 8, the branch impedance of each transformer 20A-20C is a combination of the impedances of the series winding resistance R_{w}, the inductance Lₖ, and the capacitance Cᵣ of each transformer 20A-20C. This leads to current sharing issues when the branch impedances vary among the transformers 20A-20C, such as when manufacturing tolerances lead to different Lₖ inductances among the transformers 20A-20C. In the DCX 200, the Lₖ inductance in each RC EET 210A-210C is effectively canceled, leaving the branch impedance of each RC EET 210A-210C to be only the series winding resistance R_{w} of each RC EET 210A-210C. The series winding resistances R_{w} in the RC EETs 210A-210C are typically very low (e.g., in the range of tens of milliohms) and do not contribute significantly to current sharing issues or imbalances in the DCX 200.

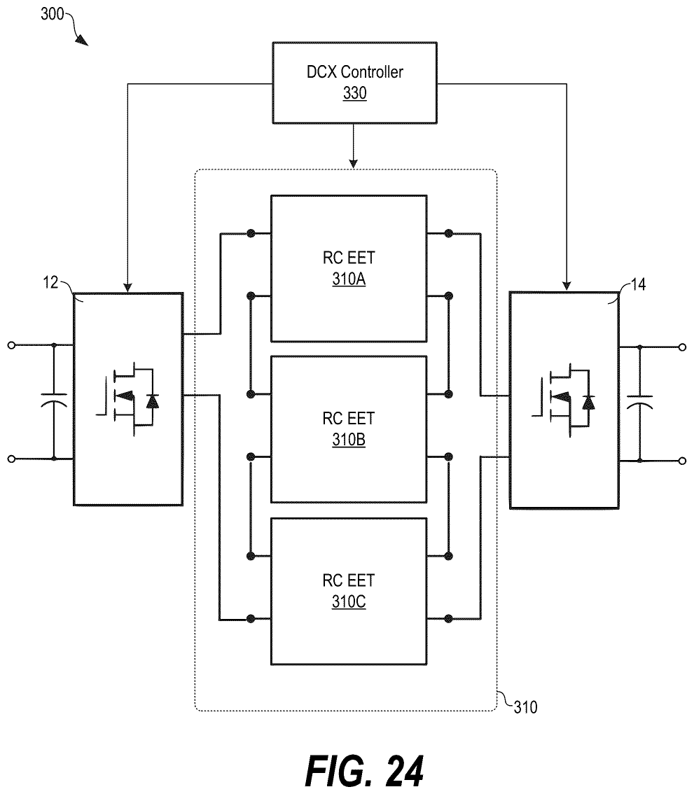

FIG. 24 illustrates an example of an RC EET-DCX 300 with a series arrangement of RC EETs according to aspects of the embodiments. The RC EET-DCX 300 is illustrated as a representative example. The RC EET-DCX 300 can vary as compared to that shown. For example, the RC EET-DCX 300 can include other components that are not illustrated in FIG. 24, such as additional RC EETs, and the RC EET-DCX 300 can omit one or more of the components that are illustrated in FIG. 24. The switching devices, transformers, controllers, and other components in the RC EET-DCX 300 can be embodied as described herein or using other suitable devices (e.g., other types of transistors, transformers, controllers, etc.), as the RC EET-DCX 300 is not limited to being implemented with any particular type or style of electronic components.

As shown, the RC EET-DCX 300 includes the first or input switching bridge 12, the second or output switching bridge 14, RC EETs 310A-310C, and a DCX controller 330. Each of the RC EETs 310A-310C is similar to the RC EET 120 shown in FIG. 9. The RC EETs 310A-310C are coupled in series between the first and second switching bridges 12 and 14 and, collectively, form an electronically-controlled series transformer 310 for high voltage applications. Although three RC EETs 310A-310C are shown, the RC EET-DCX 300 can include any suitable number of RC EETs depending on the desired power handling (e.g., voltage handling) capacity of the RC EET-DCX 300. Among possibly other components, each RC EET 210A-210C includes a bidirectional coupling switch bridge, a primary transformer winding, and a secondary transformer winding.

The DCX controller 330 can be similar to the DCX controller 130 and embodied as processing circuitry, including memory, configured to control the operation of the RC EET-DCX 300. In some cases, the DCX controller 330 can receive a metric or measure of one or more of the input voltage Vᵢₙ, the input current Iᵢₙ, the output voltage Vₒ, output current Iₒᵤₜ or power provided to a load R_{L} (not shown in FIG. 24), the operating frequency fs, or other operating metrics of the RC EET-DCX 300 as inputs, along with external control inputs.

The DCX controller 330 is configured to generate drive or switching control signals for the first and second switching bridges 12 and 14 at a switching frequency fₛ. The switching control signals direct the operation of the switching bridges 12 and 14 to transfer power between the input and the output of the RC EET-DCX 300. The DCX controller 330 is also configured to generate drive control signals based on quasi-trapezoidal current modulation control for the switching devices in the bidirectional coupling switch bridge of each RC EET 310A-310C.

The RC EET-DCX 300 offers an improvement as compared to the DCX 60 shown in FIG. 8 and described above. Particularly, even if the transformers in the RC EETs 310A-310C have small differences among Lₖ inductances in the RC EETs 310A-310C, the DCX controller 330 is configured to provide drive control signals to the bidirectional coupling switch bridges in the RC EETs 310A-310C, as described herein, for current balancing among the RC EETs 310A-310C.

Other embodiments can include combinations of the parallel transformer 210 shown in FIG. 23 and the series transformer 310 shown in FIG. 24. For example, a number of the series transformers 310 shown in FIG. 24 can be arranged in parallel with each other, similar to the way that the RC EETs 210A-210C shown in FIG. 23 are coupled in parallel with each other. This way, a power converter system can be implemented to have both high voltage and high current capabilities, while incorporating the benefits of RC EET-based current sharing and load-independent voltage gain described herein.

FIG. 23A illustrates an example of an EET module 600 according to aspects of the embodiments. The EET module 600 is illustrated as a representative example implementation of an EET according to the concepts described herein. The EETs described herein can be embodied in other ways and in other formats besides that shown in FIG. 23A. In the example shown, the EET module 600 includes a magnetic core having a first magnetic core section 610A and a second magnetic core section 610B. The EET module 600 also includes a printed circuit board (PCB) 620. The PCB 620 includes primary and secondary windings for a transformer of the EET module 600, implemented among layers of the PCB 620. Among other components, a resonant capacitor and a full bridge of switching devices can be mounted and electrically coupled to the PCB 620.

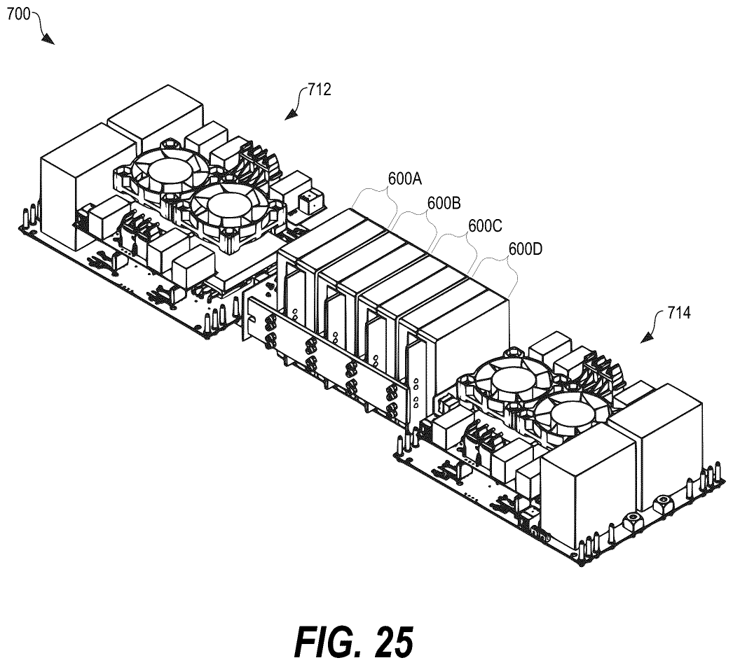

FIG. 25 illustrates an example power converter system 700 including a number of the RC EET modules according to aspects of the embodiments. The system 700 is illustrated as a representative example according to the concepts described herein. The power converter systems described herein can be embodied in other ways and in other formats besides that shown in FIG. 25. As shown, the power converter system 700 includes a first or input switching bridge 712, a second or output switching bridge 714, and a transformer coupled between the bridges 712 and 714. The transformer is implemented as a number of RC EET modules, including RC EET modules 600A-600D. The RC EET modules 600A-600D are arranged in parallel between the switching bridges 712 and 714 in FIG. 25, although other arrangements, including series arrangements and series/parallel arrangements are within the scope of the embodiments.

Use of RC EET modules, such as the RC EET modules 600A-600D, provides flexibility in the design of power converter systems 700, including in DCX converters, among others. Any number of RC EET modules can be easily added in series or parallel arrangements, to increase the power handling capacity of a power converter system.

One or more microprocessors, microcontrollers, or DSPs can execute software to perform the control aspects of the embodiments described herein, such as the control aspects performed by the controller 70, the controller 130, the controller 230, or the controller 330. Any software or program instructions can be embodied in or on any suitable type of non-transitory computer-readable medium for execution. Example computer-readable mediums include any suitable physical (i.e., non-transitory or non-signal) volatile and non-volatile, random and sequential access, read/write and read-only, media, such as hard disk, floppy disk, optical disk, magnetic, semiconductor (e.g., flash, magneto-resistive, etc.), and other memory devices. Further, any component described herein can be implemented and structured in a variety of ways. For example, one or more components can be implemented as a combination of discrete and integrated analog and digital components.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

Therefore, the following is claimed:

1. A power converter system, comprising:
an input and an output;
a power converter between the input and the output, the power converter comprising:
a first bridge of switching devices;
a second bridge of switching devices; and
an electronic-embedded transformer between the first bridge and the second bridge, the electronic-embedded transformer comprising a bidirectional coupling switch bridge; and
a controller configured to generate drive control signals for quasi-trapezoidal current modulation control of the bidirectional coupling switch bridge.

2. The power converter system according to claim 1, wherein the controller is further configured to generate the drive control signals for the bidirectional coupling switch bridge for transformer current commutation in the electronic-embedded transformer.

3. The power converter system according to claim 1, wherein the controller is further configured to:
generate switching control signals for the first bridge of switching devices and the second bridge of switching devices; and
generate the drive control signals for quasi-trapezoidal current modulation control of the bidirectional coupling switch bridge.

4. The power converter system according to claim 1, wherein:
the bidirectional coupling switch bridge of the electronic-embedded transformer comprises bidirectional switching devices Q₁ and Q₂ and capacitors Cₒ₁ and Cₒ₂;
the drive control signals control switching operations of the bidirectional switching devices Q₁ and Q₂; and
the controller is further configured to generate the drive control signals based on a commutation coefficient k and a switching frequency for the power converter.

5. The power converter system according to claim 4, wherein the commutation coefficient k is calculated based on an inductance Lₖ in the electronic-embedded transformer and a capacitance of the capacitors Cₒ₁ and Cₒ₂.

6. The power converter system according to claim 4, wherein the commutation coefficient k is calculated based on an inductance Lₖ in the electronic-embedded transformer, a capacitance of the capacitors Cₒ₁ and Cₒ₂, and a margin for resonant current commutation.

7. The power converter system according to claim 1, wherein the electronic-embedded transformer comprises a module in the power converter.

8. The power converter system according to claim 1, wherein the electronic-embedded transformer comprises a plurality of electronic-embedded transformers coupled in parallel between the first bridge and the second bridge.

9. The power converter system according to claim 1, wherein the electronic-embedded transformer comprises a plurality of electronic-embedded transformers coupled in series between the first bridge and the second bridge.

10. An electronic-embedded transformer for a power converter, comprising:
a primary winding;
a secondary winding;
a resonant inductor for use in the power converter, the resonant inductor being embodied as leakage inductance among the primary winding and the secondary winding;
a bidirectional coupling switch bridge; and
a controller configured to generate drive control signals for quasi-trapezoidal current modulation control of the bidirectional coupling switch bridge.

11. The electronic-embedded transformer according to claim 10, wherein:
the bidirectional coupling switch bridge comprises bidirectional switching devices Q₁ and Q₂ and capacitors Cₒ₁ and Cₒ₂;
the drive control signals control switching operations of the bidirectional switching devices Q₁ and Q₂; and
the controller is further configured to generate the drive control signals based on a commutation coefficient k and a switching frequency for the power converter.

12. The electronic-embedded transformer according to claim 11, wherein the commutation coefficient k is calculated based on an inductance Lₖ in the electronic-embedded transformer and a capacitance of the capacitors Cₒ₁ and Cₒ₂.

13. The electronic-embedded transformer according to claim 11, wherein the commutation coefficient k is calculated based on an inductance Lₖ in the electronic-embedded transformer, a capacitance of the capacitors Cₒ₁ and Cₒ₂, and a margin for resonant current commutation.

14. The electronic-embedded transformer according to claim 10, wherein the electronic-embedded transformer comprises a module in the power converter.

15. The electronic-embedded transformer according to claim 13, wherein bidirectional coupling switch bridge comprises a monolithic bidirectional switch.

16. A power converter system, comprising:
a power converter comprising:
a first bridge of switching devices;
a second bridge of switching devices; and
an electronic-embedded transformer between the first bridge and the second bridge, the electronic-embedded transformer comprising a bidirectional coupling switch bridge, the bidirectional coupling switch bridge comprising switching devices Q₁ and Q₂ and capacitors Cₒ₁ and Cₒ₂; and
a controller configured to:
generate switching control signals for the first bridge of switching devices and the second bridge of switching devices; and
generate drive control signals for the switching devices Q₁ and Q₂.

17. The power converter system according to claim 16, wherein the controller is further configured to generate the drive control signals for the switching devices Q₁ and Q₂ for transformer current commutation in the electronic-embedded transformer.

18. The power converter system according to claim 16, wherein the controller is further configured to generate the drive control signals based on a commutation coefficient k and a switching frequency for the power converter.

19. The power converter system according to claim 18, wherein the commutation coefficient k is calculated based on an inductance Lₖ in the electronic-embedded transformer, a capacitance of the capacitors Cₒ₁ and Cₒ₂, and a margin for resonant current commutation.

20. The power converter system according to claim 16, wherein the electronic-embedded transformer comprises a plurality of electronic-embedded transformers coupled in parallel between the first bridge and the second bridge.
